(19) United States
(12) Patent Application Publication
(10) Pub. No.: US 2018/0068280 A1
(43) Pub. Date: Mar. 8, 2018

(54) VERIFYING ELECTRONIC TRANSACTIONS

(71) Applicant: Silvio MICALI, Brookline, MA (US)

(72) Inventors: Silvio Micali, Brookline, MA (US); Sergey Gorbunov, Somerville, MA (US)

(21) Appl. No.: 15/551,678

(22) PCT Filed: Feb. 17, 2016
(86) PCT No.: PCT/US16/18300

§ 371 Date: Aug. 17, 2017

Related U.S. Application Data
(60) Provisional application No. 62/117,138, filed on Feb. 17, 2015.
(60) Provisional application No. 62/120,916, filed on Feb. 26, 2015.
(60) Provisional application No. 62/142,318, filed on Apr. 2, 2015.
(60) Provisional application No. 62/218,817, filed on Sep. 15, 2015.

(51) Int. Cl. G06Q 20/02; G06Q 20/06; G06Q 20/10; G06Q 20/22; G06Q 20/36; G06Q 20/38

(52) U.S. Cl. CPC G06Q 20/02; G06Q 20/0655; G06Q 20/0658; G06Q 20/10; H04L 9/30; G06Q 20/3678; G06Q 20/38215; G06Q 20/3825; G06Q 20/3827; G06Q 20/29

(57) ABSTRACT

Electronic payments are verified in an electronic payment system in which at each of multiple rounds there is a set of players V, such that a payment is valid if the payment is authenticated to be valid by a given majority of the players in V. Verifying the electronic payments includes having a player Vi in V receive authentication of multiple payments during one of the multiple rounds of the electronic payment system, having Vi determine which of the multiple payments are valid, having Vi authenticate a subset of the multiple payments that Vi determines valid to provide an authenticated payment record, and having Vi cause the authenticated payment record to become widely available to enable at least another entity to determine whether a given payment authenticated valid by Vi is authenticated to be valid by the given majority of the players in V.

### CROSS-REFERENCE TO RELATED APPLICATIONS

This application claims priority to U.S. Prov. App. No. 62/117,138, filed Feb. 17, 2015, and entitled “A PUBLICLY VERIFIABLE AND JOINTLY SERVICED CRYPTOCURRENCY”, and to U.S. Prov. App. No. 62/120,916, filed Feb. 26, 2015, and entitled “DEMOCOIN: A PUBLICLY VERIFABLE AND JOINTLY SERVICED CRYPTOCURRENCY”, and to U.S. Prov. App. No. 62/142,318, filed Apr. 2, 2015, and entitled “DEMOCOIN: A PUBLICLY VERIFABLE AND JOINTLY SERVICED CRYPTOCURRENCY”, and to U.S. Prov. App. No. 62/218,817, filed Sep. 15, 2015, and entitled “ALTERNATIVE USES OF DEMOCOIN”, which are all incorporated by reference herein.

### TECHNICAL FIELD

This application relates to the field of electronic transactions and more particularly to the field of verifying electric transactions using cryptography.

### BACKGROUND OF THE INVENTION

Money has been around for thousands of years. In the past, it was very physical, as in the case of gold bars or coins. However, with the emerge of computer and network technologies, electronic forms of money and payment systems have been considered. (See, for example, D. L. Chaum, Untraceable Electronic Mail, Return Addresses, and Digital Pseudonyms, Commun. ACM, Volume 24, Number 2, Pages 84-90, 1981). In principle, money can be made totally electronic. If each money transaction goes through a single, trusted, central authority A, this authority could keep track and publish, at each time t, how much everyone owns and who owns to whom. On one hand, this approach to money has the big advantage of being very efficient for users, in that the public record kept by A can be very compact and easy to consult, and yet sufficient to enable users to make payments to one another with confidence. On the other hand, however, this centralized approach also has limitations. In particular, it is hard for a large community of users to find an entity A that everyone trusts. This, in the eyes of many, continues to be true even if A were chosen to be a government. For example, the authority A could wipe out a user U's ability to pay by simply publishing that he/she/it no longer owns any money, or could make it appear that U has made payments to someone else that U never made. Thus, this centralized approach could dramatically fail if A becomes corrupt, or is compromised by adversaries, or otherwise operates improperly.

To avoid deficiencies associated with using a single, trusted, central authority, cryptocurrencies like Bitcoin have been created that are very decentralized. However, these systems require a public file (“ledger”) that is very big and very inefficient to maintain and update. Moreover, Bitcoin requires a huge amount of computation and can be subverted if the majority of the computational power falls into the wrong hands. As a result, systems like Bitcoin may not be too useful, particularly if the number of users and transactions grows.

It is thus desirable to provide an electronic money system that has the advantages of the centralized approach, but without needing to trust a central authority that maintains a public record of transactions, and without suffering the inefficiencies of known decentralized approaches.

### SUMMARY OF THE INVENTION

According to the system described herein, electronic payments are verified in an electronic payment system in which at each of multiple rounds there is a set of players V, such that a payment is valid if the payment is authenticated to be valid by a given majority of the players in V. Verifying the electronic payments includes having a player Vi in V receive authentication of multiple payments during one of the multiple rounds of the electronic payment system, having Vi determine which of the multiple payments are valid, having Vi authenticate a subset of the multiple payments that Vi determines valid to provide an authenticated payment record, and having Vi cause the authenticated payment record to become widely available to enable at least another entity to determine whether a given payment authenticated valid by Vi is authenticated to be valid by the given majority of the players in V. The authentication of at least one multiple payments may include a digital signature, determining which of the multiple payments are valid may include verifying the digital signature, authenticating the subset of multiple payments may include digitally signing data indicating the subset of multiple payments, and having Vi cause the authenticated payment record to become widely available may include posting the authenticated payment record on a website, sending the authenticated payment record to another entity that further disseminates the authenticated payment record, and/or sending the authenticated payment record to another entity that posts the authenticated payment record on a website. Digitally signing data indicating the subset of multiple payments may include using a single digital signature and the data may include information about the round, time information, and/or other additional information. Each valid payment may transfer money associated with a first public key to a second public key and each valid payment may be digitally signed relative to the first public key. Having Vi determine which of the multiple payments are valid may include determining if sufficient funds are available for each of the multiple payments. The set of players V may be randomly selected from a larger set of potential verifiers using a closeness-preserving selection process. The set of players V may be randomly selected from a larger set of potential verifiers using a natural and public random value associated with the one of the multiple rounds of the electronic payment system. Vi may be randomly selected from a set of potential verifiers by a special entity T that produces a digital signature showing that Vi has been selected and causes the signature to become widely available. The digital signature of T may authenticate information including a natural and public random value, information including time information, information including information about the one of the multiple rounds of the electronic payment system, and/or other information. Vi may be randomly selected from a set of potential verifiers by a set of special entities by combining digital signatures produced by the entities. Vi may be provided with a reward for authenticating the subset of the multiple payments that Vi determines valid. An amount of the reward may be based on a value of the multiple payments that Vi determines valid and/or a number of missed payment. The rewards may be paid by a portion of the valid payments and/or retailers that receive payments.

According further to the system described herein, verifying electronic payments in an electronic payment system includes receiving records for multiple payments from a plurality of players of the electronic payment system during a particular one of a plurality of rounds of the electronic payment system, determining which of the multiple payments are valid, authenticating valid payments to provide an authenticated payment record for each of the valid payments, and making the authenticated payment record available for accessing, where in the electronic payment system, a payment in a particular round is deemed valid if a given majority of a subset of the players authenticate as valid the particular payment to provide an authenticated payment record. Computer software, provided in a non-transitory computer readable medium, may verify electronic payments in an electronic payment system.

According further to the system described herein, facilitating verification of an electronic payment in an electronic payment system includes determining if authenticated payment records provided by a given majority of entities indicate validity of the electronic payment between a first player and a second player of the electronic payment system during a particular one of a plurality of rounds of the electronic payment system, generating an authenticated string vouching that the payment has been verified by the given majority of entities in response to the payment being verified by the majority of verification entities, and causing the authenticated string to become widely available. The authenticated string may be a digital signature and causing the authenticated string to become widely available may include posting the authenticated string on a website, transmitting the authenticated string to another entity that causes the authenticated string to become widely available, and/or transmitting the authenticated string to another entity that posts the authenticated string on a website. The authenticated payment records may be digitally signed. Computer software, provided in a non-transitory computer readable medium, may facilitates verification of an electronic payment in an electronic payment system.

According further to the system described herein, a digital certificate is issued for a particular player in a set of players V that make electronic payments in an electronic payment system in which at each of multiple rounds a payment is valid if the payment is authenticated to be valid by a given majority of the players in V. Issuing the digital certificate includes obtaining a public key PK_{X} to be used in connection with electronic payments by the particular player, obtaining additional information to be certified, and providing certification of PK_{X} and of the additional information for the digital certificate by digitally signing, with a digital signature of a distinguished entity, PK_{X} and the additional information, where certification by the distinguished entity is recognized by a significant number of the given majority of the players in V that determine validity of payments made by the players in the electronic transaction system. The additional information may include identity information about the distinguished entity, identity information about the particular player, qualifying information about the particular player, time information relating to the digital certificate, monetary information associated with PK_{X}, territorial information, and/or transaction restrictions associated with PK_{X}. The monetary information associated with PK_{X} may include an amount of money in the electronic transaction system that is possessed by the particular player. The identity information about the particular player may include the name of the particular player, a hash of the name of the particular player, an encryption of the name of the particular player, and/or an index to a data structure containing information that identifies the particular player. The identity information about the particular player may be an encryption of the name of the particular player and a governmental entity may use a decryption key to determine the identity of the particular player. Issuing the digital certificate may also include performing additional actions and, in response to a result of the additional actions being satisfactory, issuing the digital certificate containing the certification of PK_{X} and of the additional information. The additional actions may include verifying at least some of the additional information, confirming willingness of the particular player to use PK_{X} in the electronic transaction system, confirming that the particular player knows a secret signing key associated with PK_{X}, assisting the particular player to obtain PK_{X}, providing the particular player with PK_{X}. confirming that a signing key corresponding to PK_{X} has been escrowed, providing an initial amount of money to the particular player to be used in the by the electronic transaction system, determining an identity of the particular player, escrowing the information used to identify the particular player, and/or confirming that the particular player is eligible to have PK_{X} certified. The additional actions may include confirming that the particular player is eligible to be a member of the given majority of the players in V. The distinguished entity may be provided with a reward for issuing the digital certificate and/or each electronic payment made by the particular player. The reward may be provided as an electronic payment to the distinguished entity through the electronic payment system. The reward may be paid by a retailer, the particular player, and/or a recipient of an electronic payment made by the particular player. The distinguished entity may be a financial institution. Computer software, provided in a non-transitory computer readable medium, may issue a digital certificate for a particular player in a set of players V that make electronic payments.

### BRIEF DESCRIPTION OF THE DRAWINGS

Embodiments of the system described herein will now be explained in more detail in accordance with the figures of the drawings, which are briefly described as follows.

FIG. 1 is a schematic diagram illustrating a central verifier, a plurality of users, and a network, according to an embodiment of the system described herein.

FIG. 2 is a flow diagram illustrating processing performed in connection with using a central verifier, according to an embodiment of the system described herein.

FIG. 3 is a schematic diagram illustrating a plurality of verifiers, a plurality of users, and a network, according to an embodiment of the system described herein.

FIG. 4 is a flow diagram illustrating processing performed in connection with using a plurality of verifiers, according to an embodiment of the system described herein.

FIG. 5 is a schematic diagram illustrating a plurality of users and a network, according to an embodiment of the system described herein.

FIG. 6 is a flow diagram illustrating processing performed in connection with using a plurality of users that take turns providing verification, according to an embodiment of the system described herein.

### DETAILED DESCRIPTION OF VARIOUS EMBODIMENTS

The system described herein provides a mechanism for verifying electronic payments between parties the eliminates a need for a controlling central authority and also eliminates computationally intensive procedures.

### Cryptographic Primitives

Digital Signatures. A digital signature scheme consists of three fast algorithms: a probabilistic key generator G, a deterministic signing algorithm S, and a verification algorithm V.

Given a number k as an input (e.g., k=4,000), an entity x uses G to produce a pair of k-bit keys (i.e., strings): a “public” key PK_{X} and a “secret” signing key SK_{X}. A public key does not “betray” its corresponding secret key. That is, even given knowledge of PK_{X}, no one other than x is able to compute SK_{X} in less than an unrealistically large amount of time (e.g., thousands of years with the computing power of today's processors). The entity x uses SK_{X}to digitally sign messages. For each possible message (binary string) m, x runs algorithm S on inputs m and SK_{X} in order to produce a string, denoted by SIG_{X}(m) or SIG_{PKx}, referred to as x's digital signature of m, or a digital signature of m relative to PK_{X}. It may be assumed that m is retrievable from SIG_{X}(m) since a digital signature of m could always include m itself. The value of PK_{X} can be used to verify the digital signatures produced by x. Specifically, on inputs (a) the public key PK_{X} of an entity x, (b) a message m, and (c) an alleged digital signature of x for the message m, the verification algorithm V outputs either YES or NO, so as to satisfy the following properties:
1. Legitimate signatures are always verified: If s=SIG_{X}(m), then V(PK_{X},m,s)=YES; and
2. Digital signatures are very hard to forge: in essence, without knowledge of SK_{X} finding a string s such that V(PK_{X},m,s)=YES, for a message m never signed by x, requires an unrealistically large amount of time.

Accordingly, to prevent anyone else from signing messages on its behalf, an entity x must keep the corresponding signing key SK_{X} secret (hence the term “secret key”), and to enable anyone to verify the messages the entity does sign, x has an interest in publicizing key PK_{X} (hence the term “public key”).

Authentication. Digital signatures are a wonderful way to authenticate information, because public keys may be made widely available and thus the validity of the information may be widely ascertained. Information, however, could be authenticated in different ways. For instance, if two parties A and B are connected by a secure channel, then having A send some information I to B over that channel authenticates I to B, even though it will not enable B to convince someone else of the authenticity of I. As for another example, if—say—everyone knows that only A has the ability to post information on a given website W, conceptual or real, then A could authenticate I by posting it on W. Alternatively yet, if A and B share a secret key s, A may authenticate I to B by also sending the value f(s,I) for a given function f, such as an encryption function or a hash function. These and all other forms of authentication can be used the system described herein.

Certificates. Digital certificates may be used to certify public keys. A public key PK is certified by another public key PK′ via a digital signature relative to PK′. For instance, a certificate for PK may take the form

SIG_{PK′}(PK,I)

where I is any additional information deemed useful. For instance, the certifying public key PK′ may belong to another entity, such as a Bank, and I may specify the date of issuance of the certificate, the date of expiration of the certificate (if any), information about the owner of PK or PK′, information about PK or PK′ (e.g., information about the amount of money available to PK at a given moment, the creditworthiness of PK or its owner, etc.), information about the transactions (e.g., the numbers, values, etc.) done using PK, and so on, including no information. One possible interpretation of a certificate is that (the owner of) PK′ guarantees that the information I is true about PK in a way that cannot be altered by anyone else. Even if I is empty, a certificate for PK can be useful, for instance to enable a bank to guarantee that PK is part of the payment system. For simplicity, PK should be understood to signify the public key PK itself, the certified PK (or a certified PK, since the same public key may have multiple certificates), or a certificate for PK.

Collision-Resilient Hashing. A collision-resilient function H quickly maps arbitrarily long strings to strings of preferably fixed length (e.g., 256-bit strings) so as to guarantee that finding two different strings X and Y, such that H(X)=H(Y), requires an unrealistically large amount of time. Collision-resilient hashing functions may be used within digital signature schemes. If, for instance, the schemes may only sign messages consisting of at most 4,000 bits, and an entity x wishes to sign a longer message m, then the entity may sign H(m) instead. That is, SIG_{X}(m) could be defined to consist of SIG_{X}(H(m)), or of the pair (m,SIGₓ(H(m)), in order to ensure that m is retrievable from SIG_{X}(m).

Implicit Hardware. As discussed elsewhere herein a computational hardware device (e.g., an electronic chip) may be necessary to compute a digital signature. Thus, reference herein to an entity x (capable of computing digital signatures), should be understood to include x together with a hardware device used to compute digital signatures. When a function H maps a string s, with a sufficient entropy, to a binary/alphanumeric string H(s), then each bit/character of H(s) is sufficiently random. By saying that H is a hash function (e.g., a collision-resilient or one-way hash function) it should be understood that H has such a randomizing property. Similarly, evaluating such a function H may be practically impossible by hand. Accordingly, it may be assumed that H(x) is computed via a computational hardware device, as discussed elsewhere herein, such as devices contained in a computer, laptop, cell phone, or other appropriate device.

Player/User. A player (or a user) is a collection of individuals, an entity, or a collection of entities. A player i may own one or more public keys that may be identified with the player. For instance if PKᵢ is the public key of a particular player i, then the particular player may be refered to using PKᵢ and vice versa.

Money. Money can be denominated in US dollars, in another existing currency, or in a currency of its own. A monetary unit denoted by a symbol, “#”, is used herein.

Time. Time is set forth herein in a time sequence, T=0,1,2, . . . . The time interval [tᵢ, tᵢ₊₁] may be the same for all players (e.g., two minutes or one minute), but can be adjusted dynamically depending on a number of players, a number of transactions, etc. A time unit may be chosen so that, despite reasonable clock shifts, most (or all) players know the current time, t.

Payments. Money is associated with individual public keys. Initially, some public keys are publicly known to have some given amount of money. Money is transferred, via a digital signature, from one public key to another. Note however that it is possible to provide multiple money transfers, of different amounts, to different public keys by means of a single digital signature. A payment P of an amount A from a key PK to a key PK′ at a time (time) might be expressed as:

P=SIG_{PK}(PK, PK′, #A, I)

where I represents any additional information deemed useful, such as an indication of the time of the payment, the reason for the payment, or possibly no information. PK (or the owner of PK) may be referred to as the payer and PK′ (or the owner of PK′) may be referred to as the payee. As discussed elsewhere herein, an issue is determining whether PK had #A to transfer to PK′.

### Bitcoin

At a high level, in Bitcoin and different variants of Bitcoin, at every point in time, (the owner of) a given public key PK owns a given amount of money. Some of this money may be transferred from PK to another public key PK′ via a digital signature, computed with a secret key corresponding to PK. Lacking trusted central authorities, this signed transaction, T, is broadcasted over the web in a decentralized manner. That is, anyone who sees Twill forward T to their neighbors, who will forward to their neighbors, and so on. Everyone seeing Tis responsible for verifying validity of T. This verification may include verifying that the digital signature used to sign T is valid. However, verifying T also includes verifying that the key PK had sufficient money to perform a transfer indicated by T.

Verifying that the key PK had sufficient money to perform a transfer indicated by T may require validating an entire transaction history, which may not be a trivial task if the number of total transactions is large. Moreover, since one cannot guarantee that everybody has seen all transactions, it may become necessary to achieve consensus on what the current transaction history is. To simplifying this tasks, transactions are aggregated into blocks, B₁,B₂, . . . . Each block includes a hash of a previous block, a collection of new transactions, and a solution to a cryptographic riddle. The riddle depends on the previous block and the new transactions.

A user seeing blocks B₁ through Bₖ, and a collection of new (and valid) transactions, tries to aggregate the transactions into a new block Bₖ₊₁ by solving the proper riddle. The user is incentivized to do so because, if the user succeeds in generating the Bₖ₊₁ block before anyone else, then the user will will gain a monetary reward. Cryptographic riddles are sufficiently complex to solve. A single user may take a very long time to solve a given riddle. However, there are many users trying to produce a new block and thus to solve each riddle. Currently, the riddle complexity is chosen so that, in expectation, it takes 10 minutes for some user to find a solution. Ten minutes is ample time for every one to see a new block and thus gain consensus on what the transaction history is. Nonetheless, the possibility exists that two users solve the riddle sufficiently simultaneously. For instance, having seen the same block chain B₁, . . . , Bₖ, one user may succeed in producing a new block B′ₖ₊₁ and, almost simultaneously, another user may succeed in producing a block B″ₖ₊₁. In this example, each of the two users may broadcast their own new candidate block in an attempt to get the associated reward. At some point later, when even more transactions are being generated, a third user U may see two possible chains B₁, . . . , Bₖ, B′ₖ₊₁ and B₁, . . . , Bₖ, B″ₖ₊₁. To create a new block Bₖ₊₂ and collect the associated reward, U needs to decide whether to try to solve the riddle associated with the new transactions and either block B′ₖ₊₁ or block B″ₖ₊₁. Even if he does this in parallel, because solving a riddle requires a computational effort and because the reward goes to the first user who generated the block Bₖ₊₂, U will broadcast the first solution U finds in order to secure the reward. Accordingly, when the user does so, some of the other users will see a k+2-long block chain B₁, . . . , B′ₖ₊₁, Bₖ₊₂, and others will see a chain B₁, . . . , B″ₖ₊₁, Bₖ₊₂.

Because users are asked to append to the longest chain, the k+1st block should eventually become unique. In practice, although the last (or even the second last) block a user sees may change, a user may safely assume that the first k blocks in a chain of length k+2 will no longer change. Accordingly, if a transaction, belonging to the third last block, transfers an amount X from public key PK to public key PK′, then the owner of PK′ can consider himself paid.

Bitcoin Statistics. Since Bitcoin is fully a peer-to-peer protocol, every participating entity must store the entire public ledger of transactions. As of February 2015, the size of the public ledger exceeded 28 GB, which grew from 5 GB two years prior to that. The number of public keys being used as of February 2015 was about 225000, which grew from 50000 two years prior to that. Moreover, the total number of transaction at every unit of time (i.e. 10 minutes) was about 650 as of February 2015, while 2 years prior to that the number of transactions at every unit of time was only around 450 transactions. Extrapolating, at some point in time the public ledger may not fit on even the most powerful cellphones.

Also, since in the Bitcoin protocol every entity must use computational cycles on solving certain cryptographic puzzles, the total computational power of all Bitcoin players combined recently broke 1 exaFLOPS. The measure exaFLOPS refers to a number of floating-point operations a computer can do per second. Or more simply, how fast a computer can tear through math problems. An exaFLOPS is 10¹⁸, or 1,000,000,000,000,000,000 math problems per second. Note that the top 500 most powerful supercomputers can only muster a mere 12.8 percent of the total computational power of the Bitcoin entities.

Weaknesses of Bitcoin The above discussion suffices to highlight some of the inefficiencies of Bitcoin (and its variants). These inefficiencies include:
Large Storage. Users must download and store a large transaction history.
Computational Waste. To add a new block to the public ledger requires a large amount of computational resources in order to solve the necessary riddle, not only for the user that succeeds, but also for all others that tried but failed.
Payment Time. 30 minutes (or more) are needed to be sure that one is paid in Bitcoin. Assume that the owner of a public key PK pays an amount X to the owner of a public key PK′ by generating the necessary digital signature at time t. Then, to be sure that the transaction is agreed upon by everyone in the system, the owner of public key PK′ must wait 30 minutes. Indeed, since, on average, it takes about 10 minutes for this transaction to appear in a new block and another 20 minutes for this block to become the third last one.
   One may engineer things so that the expected time to add a block is lower than 10 minutes, but then this saving might also require waiting for a particular block to be more than 3-deep in order to be reasonably confident that the transaction history will no longer affect that particular block.

### Centralcoin

In Centralcoin, a special player, the central verifier, CV, is responsible to verify which money transfers are valid and to report compactly the state of the system, and cannot cheat without publicly demonstrating guilt in a way that is provable. The public key of CV, PK_{CV}, and the url of CV are publicly known.

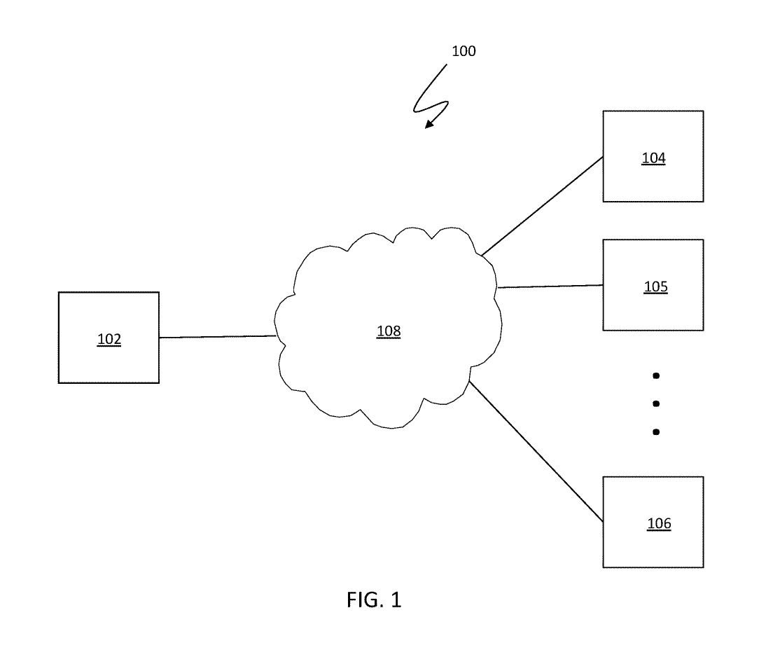

Referring to FIG. 1, a diagram 100 illustrates a central verifier 102 and a plurality of other players 104-106 connected by a network 108. The network 108 may be any appropriate network and/or mechanism to provide communication between the other players 104-106 and the central verifier 102. At least part of the network 108 may be provided by the Internet, although private and/or point-to-point direct communication may also be used. In some instances, at least some of the communication over the network 108 may be encrypted and/or generally protected from interception from malicious users although it is possible for some or all of the communication between the other players 104-106 and the ventral verifier 102 to not be protected.

The central verifier 102 and the players 104-106 may be implemented using any appropriate combination of computer hardware and software. In an embodiment herein, the central verifier 102 and the players 104-106 are implemented using computer workstations, although other implementations are possible, including one or more of the central verifier 102 and the players 104-106 being data sites containing multiple computers/processors, storage, etc.

Centralcoin works in rounds. Each round t conceptually consists of three phases (e.g., 20 seconds each), and is completed within the time interval [t, t+1] (e.g., in one minute). At the beginning of the protocol (that is, at time t=0) all players know a compact list of public keys with their initial amounts of money.

Phase 1—All players download the two CV-signed lists of the previous round, PAYₜ₋₁ and STATUSₜ₋₁; verify CV's digital signatures; and verify that STATUSₜ₋₁ was updated correctly from STATUSₜ₋₂and PAYₜ₋₁. (Alternatively, a player may only verify a subset of the status report, corresponding to his own public keys.)

Phase 2—Each player generates his own round-t payments and causes them to become available to CV.

Phase 3—CV computes, digitally signs, and publishes (e.g., at a given url) the new lists of the current round: PAYₜ, which specifies all valid payments of round-t, and STATUSₜ, which specifies the account information at the end of round t. For instance, CV may publicize
SIG_{CV}(PAYₜ) and SIG_{CV}(STATUSₜ)
   where PAYₜ=(t; P₁, P₂, . . . ) and STATUSₜ=(t; (PK₁, #A₁, I₁); (PK₂, #A₂, I₂); . . . ), and where PKᵢ is an ith public key in the system, in lexicographic order, #Aᵢ is an amount of money PKᵢ has, Iᵢ is any additional information about PKᵢ, and nₜ₋₁ is a total number of public keys at time t−1.

As discussed elsewhere herein, a payment P may be of a form P=SIG_{PK}(PK, PK′, #A, I). The list may be ordered by the paying public key first, by the paid public key PK′ second, and by the amount, A, third. A payment is valid if the signature of the paying key is valid, and if the amount is valid, relative to the amount of money that PK had at the end of round t−1 and all the preceding round-t payments of PK. For instance, if, according to status Sₜ₋₁, PK has #A at the end of round t−1, the first k payments (sorted by time) of PK in round t−1 have a valid signature of PK and have a total amount of A′<A, while the amount of the k+1st payment of PK is greater than the remaining balance A-A′, then the k+1st payment of PK may not be considered valid.

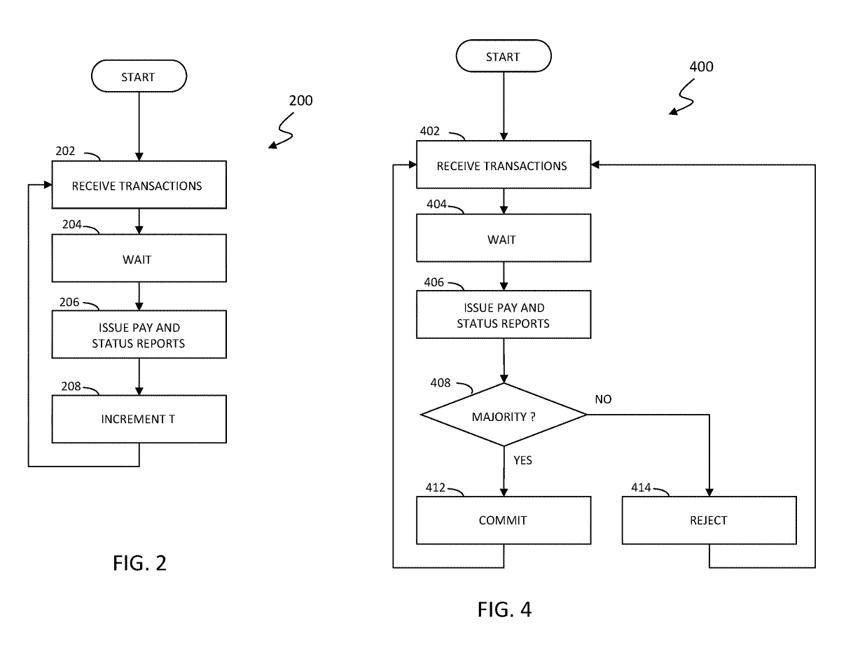

Referring to FIG. 2, a flow diagram 200 illustrates operation of Centralcoin. Processing begins at a first step 202 where the central verifier receives transactions from the other players. Following the step 202 is a step 204 where the central verifier waits a predetermined amount of time for the round. As discussed elsewhere herein, in an embodiment herein, each round may be a fixed amount of time. Note that the steps 202, 204 may be combined so that, essentially, the central verifier receives transactions for a predetermined amount of time corresponding to the time for each round. Following the step 204 is a step 206 where the central verifier issues Payₜ and Statusₜ, as described elsewhere herein. Prior to issuing Payₜ and Statusₜ, the central verifier may perform verification such as verifying digital signatures of the other players for each transaction and verifying that no transaction causes a player to have a balance less than zero. Following the step 206 is a step 208 where t, the iteration counter (round counter), is incremented. Following the step 208, control transfers back to the step 202 for another iteration.

Centralcoin provides ultra compact records where a full status of the system is relatively compact. A new public key PK′ may enter the system via a payment (PK, PK⁰, #A, I) appearing in PAYₜ at some round t. Alternatively, CV, or a different entity, may register new keys that first appear with a balance of zero in STATUSₜ at some round t.

Authenticating the lists PAYₜ and STATUSₜ may be very efficient, since CV computes a single signature for each list. However, a player wishing to keep an authenticated record only for a single payment at round t, would have to download the entire PAYₜ. Similarly, a player wishing to keep an authenticated record for the balance of money available to a given public key at the end of round t would have to download the entire STATUSₜ. To lessen this burden of such a player, CV may digitally sign each entry in PAYₜ or STATUSₜ. In this case, however, it may be challenging for CV to produce so many digital signatures within a single-round phase. Accordingly, it may be advantageous to to have the CV tree-hash (rather than simply one-way hash) the two lists, and then digitally sign just the root of each hash tree. Advantages of this approach are that CV can authenticate each entire list by means of a single digital signature and one ordinary hash for each entry in the list, the digital signature authenticating the list may be compact (i.e. independent on the number of entries in the list), and someone interested only in the authenticated record about a given item in either list may have to deal only with a minimal amount of data. Tree-hash-and-sign mechanisms are discussed in more detail elsewhere herein. See also U.S. Pat. No. 6,097,811, which is incorporated by reference herein.

Note that, in Centralcoin, CV need not be totally trusted, because it is transparent. When a player X is transparent, then if X acts dishonestly, X produce a widely available proof of the dishonesty. Since a provably dishonest party can be heavily punished (e.g., heavily fined or jailed, if a person), one can be relatively confident that a transparent player will act honestly (i.e., act in a prescribed way). Note that transparency is a useful, if not crucial, property in a financial system. Indeed, what one should really fear is dishonesty that goes undetected. In the system described herein, all players are essentially always transparent, or, in some cases, prevented from being dishonest.

Lacking knowledge of the secret key SK corresponding to a given public key PK, CV could not manufacture a payment from PK to some other public key PK′, even if CV wanted to do this and did not fear any punishment. In addition, CV cannot, without being caught, illegally diminish the amount of money PK has. Indeed, assume that CV does so, for the first time, at some round t. Then, in a previous round, CV has already correctly signed the correct STATUSₜ₋₁. Thus, the only legitimate way of decreasing the amount of money of PK in STATUSₜ consists of subtracting all the amounts that PK has paid to other keys in round t (and adding all the payments PK received in round t). Since these transfers are digitally signed by PK, when CV digitally sign a STATUSₜ in which he incorrectly lowers the money available to PK, CV digitally signs something patently false, generating a public proof of the dishonesty of CV.

In addition, CV could still, however, try to prevent money to be transferred from some key PK to some other key PK′. That is, CV may prevent the owner of PK (respectively, PK′) from using (respectively, receiving) any money. In fact, although timely receiving a valid round-t payment P=SIG_{PK}(PK, PK′, #A, t, I), the CV may not include Pin PAYₜ. In such a case, it may be hard for the owner of PK (or PK′) to prove that he indeed did give P on time to CV. It is a question of whom one believes. One way to keep CV unambiguously accountable for this type of cheating is to utilize technology of U.S. Pat. No. 5,666,420, Simultaneous Electronic Transactions, which is incorporated by reference herein. In essence, this technology guarantees the exchange a message for a receipt so that (a) the recipient of the message learns the message simultaneously with (b) the sender getting a corresponding, very detailed, and digitally signed receipt. In the system described herein, the message consists of the payment P, the receiver is CV, and CV cannot learn P without also signing a receipt for P. In this fashion, whether the sender is the owner of PK or the owner of PK′, or someone acting on their behalf, CV could not, with impunity, ignore the payment P. Indeed, using Simultaneous Electronic Transactions, CV produces a digital signature proving that CV received P on time, and thus proves guilt if CV does not include P in PAYₜ, a list that CV digitally signs. Thus, with simultaneous electronic transactions, Centralcoin may be free of undetected cheating, and with treehash-and-sign, Centralcoin may guarantee efficient storage and retrieval of even individual authenticated records. However, Centralcoin may be prone to sabotage since CV is a unique point of vulnerability.

### Spreadcoin

In Spreadcoin, there are multiple verifiers, V₁, . . . , Vₖ. Each verifier V, has a public key, VPKᵢ, and a corresponding secret key, VSKᵢ. In some embodiments, k is odd: e.g., k=11. Spreadcoin only relies on an opinion of a a given majority of the verifiers. Spreadcoin works securely if such a majority of verifiers are at least transparent, let alone honest. For instance, if k=15, then Speadcoin relies on the opinion of at least 8 verifiers, if a simple majority is adopted, and on the opinion of at least 10 verifiers, if a ⅔ majority is adopted.

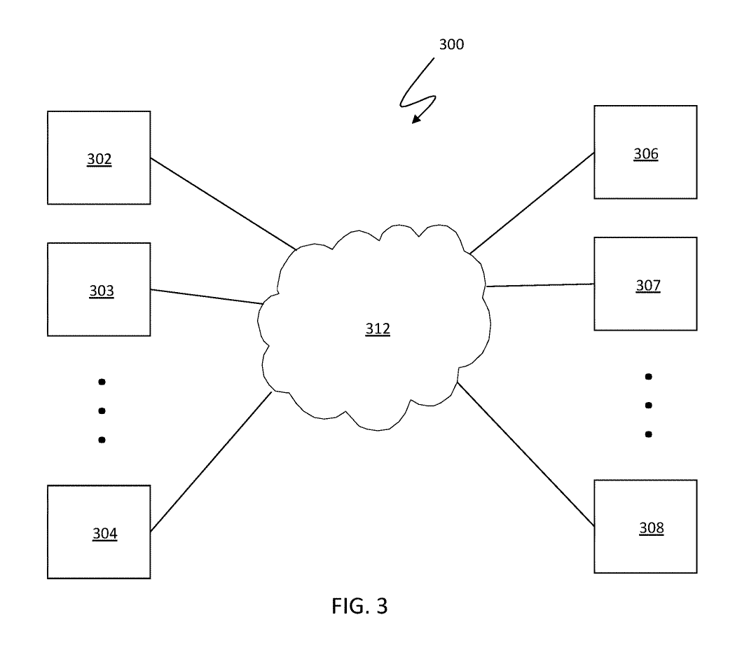

Referring to FIG. 3, a diagram 300 illustrates a plurality of verifiers 302-304 and a plurality of other players 306-308 connected by a network 312. The network 312 may be any appropriate network and/or mechanism to provide communication between the other players 306-308 and the verifiers 302-304. At least part of the network 312 may be provided by the Internet, although private and/or point-to-point direct communication may also be used. In some instances, at least some of the communication over the network 312 may be encrypted and/or generally protected from interception from malicious users although it is possible for some or all of the communication between the other players 306-308 and the verifiers 302-304 to not be protected.

The verifiers 302-304 and the other players 306-308 may be implemented using any appropriate combination of computer hardware and software. In an embodiment herein, the verifiers 302-304 and the other players 306-308 are implemented using computer workstations, although other implementations are possible, including one or more of the verifiers 302-304 and the other players 306-308 being data sites containing multiple computers/processors, storage, etc.

Spreadcoin works in rounds where, at each round t, a verifier Vᵢ operates as follows:

Phase 1

Vᵢ obtains a number of payments relative to round t.

For instance, if P is such a payment, then it may be the payer that sends P to Vᵢ or causes P to be obtained by Vᵢ for further processing, as the payer may want to make it clear in the system that the payer has indeed made the payment P. Alternatively, after receiving P, it may be the payee who may send P to Vᵢ or causes P to be obtained by Vᵢ, as it is in the interest of the payee to make it clear in the system that the payee has been paid.

Phase 2

Vᵢ determines which of the received payments of round t Vᵢ considers valid.

In particular, in identifying the received valid payments of round t, Vᵢ may disregard duplicate payments. To identify as valid a round-t payment P, made by a public key PK to another public key PK′ for an amount A (e.g., P=SIG_{PK}(PK, PK′, #A, I)), Vᵢ may conduct several checks. For instance, Vᵢ may verify that PK is properly certified, if certificates are used in the system, verify that the digital signature relative to PK is correct, verify (e.g., by consulting the proper information within STATUSₜ₋₁) that the amount of money A is indeed less than or equal to an amount of money available to PK in the previous round, and verify that P was received at the proper time for round t and/or P's time information is appropriate for round t. More generally, if Vᵢ receives multiple round-t payments made by a public key PK, then Vᵢ may verify that the sum of the amounts of all such payments is less than the amount available to PK in the previous round. When, in a given round, Vᵢ receives multiple payments made by PK whose total amounts exceed the amount previously available to PK, then a variety of choices could be made by Vᵢ. In particular, Vᵢ may not include any payment made by PK among the valid received payments of round t. Alternatively, Vᵢ may include only a subset payments made by PK, where a total amount of the subset does not exceed an amount of money previously available to PK. For example, Vᵢ may include a longest subsequence of payments of PK (e.g., in lexicographic order) in which the total amount paid does not exceed the amount of money available to PK in round t−1.

Phase 3

Vᵢ authenticates, preferably together, the round-t payments that Vᵢ determines to be valid, and causes such payments to be available to at least another entity E, and preferably actually causes such payments to be made widely available.

Letting P₁ⁱ, P₂ⁱ, . . . be the round-t payment that Vᵢ determines valid, Vᵢ preferably computes and makes widely available PAYₜⁱ=SIG_{VPK}_{ₜ}(P₁ⁱ, P₂ⁱ, . . . , I).

By so doing, Vᵢ helps a user U to determine which round-t payments are deemed valid by a given majority of verifiers. For instance, assume that there are 100 verifiers, and that each verifier Vᵢ posts PAYₜⁱ in a website for each verifier or in a common/public website of, for example, Google or Amazon. Then, U can easily reconcile the authenticated information so as to determine PAYₜ, essentially the round-t payments deemed valid by a given majority of the verifiers.

Note that U may be able to compute PAYₜ without obtaining PAYⁱₜ from all verifiers i, and that U can be assured that a payment P is valid without obtaining PAYⁱₜ from all verifiers i. For instance, assume that there are 100 verifiers and that the payee of a payment P tries to cause P to be obtained by all verifiers, but that only 90 verifiers only obtain P and authenticate P to be valid, and that U obtains PAYⁱₜ from only 80 of these 90 verifiers. Then, U is still guaranteed that P is valid. For instance, assume that there are 100 verifiers, and that a payment P is valid if at least a simple majority of the verifiers deem P valid. Then if U obtains PAYₜⁱ only from, for example, 80 verifiers i and 60 of them authenticate P as valid, then U is guaranteed that P is valid. This robustness is useful, because occasionally some of the verifiers may not be able to communicate a determination for any number of reasons, such as the verifiers being disconnected from the network or the computers of the verifiers being temporarily out of order.

Note also that a user U may not, at some round, be able to learn PAYₜ (e.g., because the user was disconnected from the network). In any case, since the information from the verifiers is made widely available, U could always catch up, for example, one or two rounds later. When U is unable to compute STATUSₜ₋₁, U may ask another user not to make a payment to U in round t but, instead, in a round later than round t. Alternatively, U may prefer not to rely on a payment P made to U by another user X in round t. For instance, if U was supposed to provide X with some merchandise or service in return for P, U may wait one or more rounds to do so, when U finally learns STATUSₜ₋₁. In sum, the system is robust enough that everyone can, albeit slightly later, compute PAYₜ.

Also note that, from PAYₜ and STATUSₜ₋₁, U can then readily compute STATUSₜ. In fact, if U had computed (or otherwise knew) STATUSₛ, for a round s<t−1, then, given PAYₛ₊₁^{j}, . . . , PAYₜ^{j} for sufficiently many verifiers j (values that have been made available anyway), the user could compute STATUSₜ.

Referring to FIG. 4, a flow diagram 400 illustrates operation of Spreadcoin. Processing begins at a first step 402 where the each of the verifiers receives transactions from the players. Following the step 402 is a step 404 where the verifiers wait a predetermined amount of time for the round. As discussed elsewhere herein, in an embodiment, each round may be a fixed amount of time. Note that the steps 402, 404 may be combined so that, essentially, the verifiers receive transactions for a predetermined amount of time corresponding to the time for each round. Following the step 404 is a step 406 where the verifiers issue Payₜ and Statusₜ, as described elsewhere herein. Prior to issuing Payₜ and Statusₜ, the verifiers may perform verification such as verifying digital signatures of the other players for each transaction and verifying that no transaction causes a player to have a balance less than zero.

Following the step 406 is a test step 408 where it is determined if a majority of verifiers (as specified for a particular implementation) agree, as described elsewhere herein. If so, then control transfers from the step 408 to a step 412 where the round is confirmed (i.e., t is incremented). Following the step 412, control transfers back to the step 402 for another iteration. If it is determined at the step 408 that a majority of verifiers do not agree, as described elsewhere herein, then control transfers from the step 408 to a step 414 where the round is rejected (i.e., none of the transactions in the round are confirmed), as described elsewhere herein. Following the step 414, control transfers back to the step 402 for another iteration.

Optional Verifier Phase

Vᵢ uses the values PAYₜⁱ of other verifiers j to determine, authenticate, and make widely available PAYₜ. For instance, Vᵢ posts SIG_{VPKi}(PAYₜ). From all authenticated information available to him, Vᵢ may also compute, authenticate, and make widely available STATUSₜ. For instance, Vᵢ posts SIGᵢ(STATUSₜ).

Note that, while in Bitcoin valid transactions are organized in blocks, and in Spreadcoin valid transactions are organized in rounds, it is possible to ensure that an expected time T to generate a block equals a duration of a round. However, an amount of computation expected during T is by design very large in Bitcoin and very modest in Spreadcoin. Note that, for convenience, in Phase 2, Vᵢ authenticates the payments Vᵢ considers valid all together, by means of a single digital signature. It is also possible, however, to have Vᵢ authenticate the payments separately (e.g., one by one) using multiple digital signatures. Also, the number of payments that Vᵢ obtains in Phase 1, could be all round-t payments, or part of the round-t payments. In particular, Vᵢ could handle a given class of the round-t payments. For instance, Vᵢ could handle round-t payments whose payer, or payee, belongs to a given set or is somehow associated with Vᵢ. More generally, it is possible to evaluate a given function to a payment P in order to determine that Vᵢ could handle P. The time or the amount of a payment P may determine whether Vᵢ handles the payment P, and so on. No matter what the case may be, if some verifiers handle only some of the payments, whether a payment P is valid may depend on the opinion of only the verifiers handling P, rather than all verifiers.

Optional Use of Facilitators

Spreadcoin may also use one or more special entities E, such as a Bank or a large firm such as Google or Amazon, to make it even easier for an ordinary user U to learn the valid transactions or the system status at a round t. In particular, in the system described herein, for each round t after the above phases, such an entity E could execute the following:

Transparent Facilitator Phase

Using the authenticated round-t information made available by sufficiently many (although not necessarily all) verifiers, E may compute, authenticate, and make widely available PAYₜ, STATUSₜ, or both, or other information deemed useful, either by separately, or together, or in combination.

Alternatively, E may relay, possibly re-organizing, combining, authenticating, or further authenticating, the round-t information of at least some verifiers.

Alternatively yet, E may compute, possibly authenticate, and cause to make available information that, together with information made available by at least another entity E′, enables the computation, possibly in authenticated form, of at least one of: PAYₜ, STATUSₜ, both, or a combination thereof. For instance, E may post SIG_{E}(PAYₜ, I), SIG_{E}(STATUSₜ, I), SIG_{E}(PAYₜ, STATUSₜ, I), SIG_{E}(PAY₁¹, . . . , PAYₜ^{k}, I), or SIG_{E}(STATUSₜ, PAY₁¹, . . . , PAYₜ^{k}, I), where I is any additional information, such as information about t, time information, or no information.

For instance, if there are 100 verifiers, a user (e.g., a new user) U may learn the information about a given round t directly from E, and in an authenticated form, without having to obtain relevant round-t information of sufficiently many verifiers. For instance, U may learn STATUSₜ from SIG_{E}(STATUSₜ), or PAYₜ from SIG_{E}(PAYₜ). Notice that E needs not be trusted very much, because E is a transparent player. Indeed, E publicizes and authenticates the round-t information that E produces, and a player can use current and past verifier-authenticated information, that is made available anyway, to check that information provided by E is correct. And if information provided by E is not correct, then E itself would be providing a proof of dishonesty by E. Thus, if E is a bank or a player with significant assets, E would have a lot to lose by being caught misbehaving. It is also possible to provide rewards to someone who catches E acting dishonestly.

Generally, the verifiers are responsible to determine which payments are valid, but, without being able to lie with impunity, E may facilitate dissemination of determinations by the verifiers. In some instances, separate entities may take the role of E. In this case (separately from possible fines), the current status may be determined from the information provided by each entity E. For instance, an entry (PKⱼ, #Aⱼ, Iⱼ) may belong to STATUSₜ if and only if, for a given majority of the entities E, the entry belongs to the (preferably authenticated) round-t status reported by E. Note also that a verifier itself can take the role of E.

(In an embodiment herein, only one payment per player per round is allowed. This can be validated at any phase during the round by any of the players, verifiers, or by the facilitator. For instance, if an entity detects that a cheating player is trying to perform two or more transactions in a round, then the entity signals a special message to everyone in the system indicating the possible cheating. The special message may include the two payments from the cheating player, or any other information that can be used to prove the cheating attempt. The cheating player may be punished by penalties, or suspended from the system. In this case, the report STATUSₜ may be updated accordingly to reflect the punishment/penalties for all players involved in the cheating transactions—i.e., the cheating player and corresponding receiver(s) from the cheating player.)

With respect to efficiency, as with Centralcoin, the system Status generated by Spreadcoin is also relatively compact. Handling 650 transactions every 10 minutes, and 275000 keys (as in Bitcoin) is not a problem for Centralcoin. Even with a million public keys and a one million transactions every minute, Centralcoin would be much preferable to Bitcoin's public ledger.

With respect to security, it is noted that an individual verifier Vᵢ in Spreadcoin need not be trusted. Indeed, Vᵢ cannot fake from scratch a payment P of a different user. Each payment, in fact, must be digitally signed with the public key PK od a peyer, and thus requires knowledge of a corresponding secret key SK, which only the owner of PK should have. For the same reason, V cannot even alter the amount, the payee, the time, or anything else about a legitimate payment P. One issue that may preven Vᵢ from being totally transparent is that (unless the previously discussed Simultaneous Electronic Technology is used) Vᵢ can avoid recognizing a legitimate payment P: e.g., by not including the payment into PAYₜⁱ. Even if it is noticed that P is recognized by other verifiers but not by Vᵢ, Vᵢ could always credibly claim not to have received P. Such lack of total transparency is not, however, serious given the way the system operates. If sufficiently many other verifiers j include P in Payₜ^{j}, then by reconciling all the verifier data and taking the proper majority, anyone can correctly reconstruct PAYₜ, that is, all the legitimate payments of round t.

In particular, if a sufficient majority of the verifiers recognize legitimate payments, then the malicious verifiers, even if they collude and perfectly co-ordinate themselves, cannot subvert Spreadcoin.

In addition, as described in more detail elsewhere herein, rather than just relying on the abstract honesty of the majority of the verifiers, Spreadcoin may properly incentivize each verifier to recognize as legitimate all legitimate payments.

Spreadcoin also provides resilience to protect against verifiers that stop working. For instance, some verifiers may become disconnected from the network, and thus unreachable and unable to perform functions of the verifiers, or sites of some verifiers may be brought down by an adversary who wishes to subvert Spreadcoin. To subvert Spreadcoin, when simple majority is needed, an enemy would have to successfully bring down more than half of the sites, e.g., 6 of 11 sites, if the number of verifiers is k=11, or 51 out of 101, if k=101.

Spreadcoin can be enhanced by the use of facilitators. As discussed elsewhere herein, one or more entities E may be used, after the verifiers act at a given round, in order to facilitate the use of the system. Such facilitating entities may also help at the beginning of a round. For instance, to avoid sending a payment to multiple verifiers, a player may just send the payment to a facilitator E, who then distributes the payment to the verifiers, or posts the payment where the verifiers can pick it up. Of course, the players can always deal directly with the verifiers, if the facilitator(s) do not work satisfactorily. A same entity E can actually facilitate the system at the beginning and at the end of a round.

It is also possible to use a weighted majority. In the examples of majority discussed above (whether simple majority, ⅔ majority, and so on), the verifiers/verifier keys have been treated equally. However, a majority could also be a weighted majority where it is possible to give more weight to some verifiers/verifier keys than to others. For instance, if there are 100 verifiers/verifier keys and simple majority is used, then it is possible to weight results from a particular verifier/verifier key, V/VPK, ten times more than the other verifiers so that if a given round-t payment P may be considered valid if 51 of the verifiers/verifier keys consider P valid, P may also be considered valid if V/VPK and some other 41 verifiers/verifier keys declare P valid. A verifier key considers a payment P valid if P is authenticated as valid relative to the verifier key.

### Rewarding the Verifiers

As discussed elsewhere herein, in Spreadcoin, a dishonest verifier Vᵢ cannot fake or modify legitimate payments, but could purposely fail to include in PAYₜⁱ a valid payment P. If sufficiently many verifiers did so for a payment P made by a given public key PK, P will not enter PAYₜ and the payer would have to make the payment again in the next round, if the payer so chooses. But if sufficiently many verifiers consistently do this at each round, then, although the owner of PK will not lose his money, he will lose the ability to spend it (and might need go to court to recover it). It is thus useful to ensure that, without involving courts or other expensive or inefficient processes, a verifier Vᵢ is disincentivized from not identifying a valid round-t payment P. To this end, it is possible to reward Vᵢ for work done by Vᵢ, as follows:

Phase 4

Vᵢ obtains a reward Rₜⁱ that may depend on (a) the payments identified by Vᵢ and/or other verifiers to be valid, and/or (b) other quantities Q, such as t, i, quantities of other rounds, etc. or no quantities.

For instance, letting Aₜ be the sum of the amounts of all payments in PAYₜ or in PAYₜⁱ, Vᵢ may get a percentage—e.g., 1%—of Aₜ. Thus, by not including a valid payment Pin PAYₜⁱ, Vᵢ risks of decreasing Aₜ and thus risks decreasing the reward for Vᵢ. In particular, the total reward for all verifiers at a given round may be a given fraction c of Aₜ, and the reward due to verifier Vᵢ may be

$$\frac{{cA}_{t}}{k}$$

if there are k verifiers and the verifiers are treated equally. Alternatively, the reward of Vᵢ may be a different portion of a total reward due to all of the verifiers.

It is also possible to use rewards that may cause Vᵢ to incur a risk of receiving much less money even when Vᵢ omits to identify as valid a single payment relative to a small amount of money. For instance, the reward of Vᵢ may consist of a fraction cᵢ·Aₜ if every payment in PAYₜ also appears in PAYₜⁱ; it may consist of

$$\frac{{c}_{i} {A}_{t}}{2}$$

if exactly one payment in PAYₜ does not appear in PAYₜⁱ; it may consist of

$$\frac{{c}_{i} {A}_{t}}{4}$$

if exactly two payments in PAYₜ do not appear in PAYⁱₜ; and so on. In any case, the reward of Vᵢ at a round t may be determined so as to cause Vᵢ to incur the risk of receiving strictly less many whenever Vᵢ omits of recognizing as valid a valid transaction, possibly not only in a given round, but also, for example, in future rounds too.

The system provides automatic reward payments. No matter how rewards may be computed, a verifier Vᵢ may receive a reward in any way deemed appropriate, such as via a separate payment made by some entity E. Alternatively, as an ordinary user of the system, Vᵢ may have a public key PKᵢ, capable of holding money and paying money to others, that may be separate from a public key Vᵢ uses to digitally sign the payments Vᵢ believes valid. In this case, a current Status of the system may contain information about the amount of money available to PKᵢ: for instance, the current Status may contain an item of the form (PKᵢ, #a, I). Thus, there is no need to rely on a external payment in order to reward Vᵢ, nor on a separate payment to PKᵢ within the system. For instance, it suffices that everyone automatically updates the amount of money PKᵢ holds in, for example, STATUSₜ or in a given later round, so as to reflect the reward due to Vᵢ for work by Vᵢ in round t. For instance, assume that STATUSₜ₋₁ contained the item (PKᵢ, #a, I), that the reward of Vᵢ for round t simply consists of a fraction c of Aₜ, and that Vᵢ does not use PKᵢ to make any payment in round t. Consider any party X that uses the verifier-digitally signed quantities PAYₜ¹, . . . , PAYₜ^{k} in order to compute STATUSₜ from STATUSₜ₋₁. In such a situation, U can trivially compute c·Aₜ from PAYₜⁱ and can trivially replace the entry (PKᵢ, #a, I) in STATUSₜ₋₁ with (PKᵢ, #a+c·Aₜ, I) in STATUSₜ.

The system provides for budget balance rewards. The automatic reward system described above generates some “inflation”, in that, at each round, the reward system causes the total amount of money available to all public keys in the system to increase. However, that such “inflation” can be avoided by having the rewards due to the verifiers be paid by some/all/other users in the system. Such payments may also be automatic. For instance, assume, for simplicity, that the total reward of all verifiers Vᵢ is 1% of the total amount of the valid payments of round t. Then, inflation may be avoided if, for each valid round-t payment P of an amount a, an additional payment of 1% of a is made to the verifiers by the payer or by the payee of P, (or in part by the payer, and the balance by the payee). To make this payment automatic, assume that P is made at round t from a public key PK to another public key PK′. Then an additional 1% of a may be automatically subtracted from PK in STATUSₜ by whoever compute STATUSₜ. Alternatively, 1% of a may be subtracted automatically from PK′; or part of this amount can be subtracted from PK, and the balance from PK′. Alternatively yet, the payment, automatic or not, may be spread across other entities who have the interest to keep the system inflation-free.

The system provides for rewards from retailers only. In some instances, having the payee (or the payer) of a payment P contribute a reward to the verifiers, or to some of the verifiers, may be viewed as a transaction fee. Paying a transaction fee may be acceptable by some users, such as retailers, but not by other users. For instance, an ordinary user U wishing to transfer $100 to another user ordinary U′ may find it unacceptable to pay $1 to the verifiers; and similarly U′ may find it unacceptable to receive de facto only $99. Accordingly, the rewards of the verifiers may be computed on the amounts paid to retailers, and come from the retailers themselves. For instance, if a public key PK is certified, then a certificate of PK can also specify (e.g., within the information field I) that PK indeed is owned by a retailer. This way it may be relatively easy to recognize whether a payment P is made to the public key of a retailer, and thus whether the verifiers can claim some fee on this transaction. In contrast, when a payment is from an ordinary user to another ordinary user, neither the payer nor the payee may be required to pay a reward to the verifiers. In principle, therefore, it is possible for a verifier V, to avoid including such payments in PAYₜⁱ without incurring any monetary loss.

It is possible, however, to determine the reward of a verifier Vᵢ at round t from the quantities specified in Phase 4, so that Vᵢ is incentivized to report as valid every round-t payment P, that is indeed valid, whether or not, for example, the payee is a retailer. For instance, if all k verifiers are treated equally, and if the rewards of the verifiers are (automatically) paid by just the retailers, and the total rewards due are 1% of RAₜ (where, considering all payments in PAYₜ, RAₜ is the sum of all amounts paid to retailers), then it suffices for the reward of Vᵢ to be:

$$\frac{1}{100} \cdot \frac{1}{k} \cdot {RA}_{t} \frac{{T}_{t}^{i}}{{T}_{t}}$$

where Tₜⁱ is the total number of payments in PAYₜⁱ that also appear in PAYₜ, and Tₜ is the total number of payments in PAYₜ.

Thus, although only the retailers de facto pay the reward of Vᵢ, Vᵢ risks loosing money if Vᵢ does not include in PAYₜ all the round-t payments Vᵢ deems valid, including payments from ordinary users to ordinary users. To make it more risky to omit even a single payment, no matter to whom, the reward of Vᵢ could be chosen to be:

$$\frac{1}{100} \cdot \frac{1}{k} \cdot {RA}_{t}$$

if every payment in PAYₜ occurs in PAYₜⁱ;

$$\frac{1}{100} \cdot \frac{1}{k} \cdot \frac{{RA}_{t}}{2}$$

if exactly one payment in PAYₜ does not occur in PAYₜⁱ;

$$\frac{1}{100} \cdot \frac{1}{k} \cdot \frac{{RA}_{t}}{4}$$

if exactly two payments in PAYₜ do not occur in PAYₜⁱ;
and so on.

### Democoin

Democoin is a variation of Spreadcoin in which the verifiers of a given round are chosen at random, specifically by means of the following:

### Verifier Selection Phase

For each round t, the set of actual verifiers is randomly selected from a possibly larger set of potential verifiers by a selection process which is preferably closeness-preserving, that is, by a selection process that generates (sub)sets close to each other from sets close to each other.

Note that the term “random”, as used herein, should be understood to include “sufficiently random” or “pseudo-random”. Similarly, and the term “randomly” may also be understood to include “sufficiently randomly” or “pesudorandomly”.

Two sets A and B are close to each other (or essentially identical) if the elements in A but not in B are relatively few with respect to the elements in both A and B; and vice versa for B. For instance, the set of all numbers between 1 and 1,000, and the set of all numbers between 10 and 1,012 may be considered close to each other. Of course, two identical non-empty sets are always close to each other. Assume, for a moment, that each user may have a single public key in the system. Then, identifying a key with a user of the key, it is possible to view AV as the set of all actual-verifier keys and PV as the set of all potential-verifier keys. The concept of a verifier being honest is discussed elsewhere herein. Notice that if a given majority of PV is honest and AV is randomly select in PV, then, with high probability, when AV is large enough, a given majority of AV is also honest

Closeness. It is useful to the proper running of the Democoin system that the valid payments of a given round should be correctly determined and agreed upon. Since such payments are determined by a given majority of the actual verifiers, if the majority of AV are honest and all users agree on AV, then the system will run properly. Note that, if the majority of PV are honest, then, with high probability, so are the majority of AV, when the number of actual verifiers is sufficiently high, because AV is randomly selected from PV. Also note that it is not necessary that all users agree on AV. The system runs well even if each user U has his own set AV_{U} that the user believes to be AV, provided that each such AV_{U} is close to AV, or that all AV_{U} are close, since any one of them could be considered to be AV. In essence, this is so because, with very high probability, if the overwhelming majority of PV are honest, then so are a given majority of AV and of any subset of PV close to AV.

One way to ensure that each AV_{U} is close to AV (or that all AV_{U} are close) is to ensure that the set PV is fixed, and have each user U use a closeness-preserving selection process to select his own AV_{U} from PV. Another way, as explained elsewhere herein, is to choose the set PV so that, even though PV may vary over time, and each user U may honestly conclude that the set PV_{U} owned by each user is the set of the potential verifier, it must be that PV_{U} and PV are close (or that all sets PV_{U} are close), so that also all sets AV_{U} are close.

Incentives. As Democoin consists of Spreadcoin with a special way of selecting the verifiers, the same reward schemes discussed for Spreadcoin can be used in Democoin to ensure that, at a round t, the actual verifiers authenticate as valid all the round-t payments that are seen by the verifiers, except perhaps for the verifiers that possibly inoperative verifiers, such as verifiers that become disconnected from the network, or verifiers whose computer(s) malfunction, etc. Accordingly, an overwhelming majority of verifiers of a round t can be expected to report correctly the round-t valid payments.

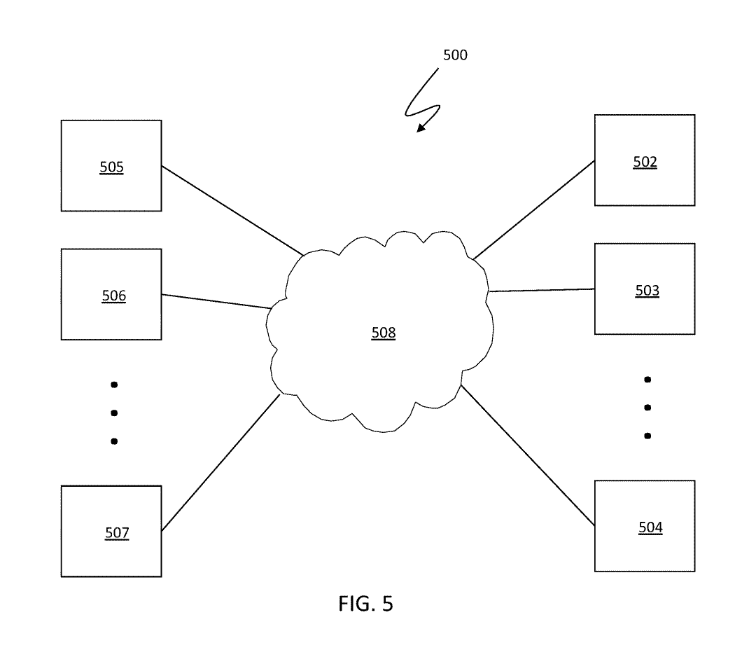

Referring to FIG. 5, a diagram 500 illustrates a first plurality of players 502-504 and a second plurality of players 505-507 connected by a network 508. The network 508 may be any appropriate network and/or mechanism to provide communication between the players 502-507. At least part of the network 508 may be provided by the Internet, although private and/or point-to-point direct communication may also be used. In some instances, at least some of the communication over the network 508 may be encrypted and/or generally protected from interception from malicious users although it is possible for some or all of the communication between the players 502-507 to not be protected. As discussed elsewhere herein, a subset of the players 502-504 may be selected as verifiers for each round and different subsets may be chosen for different rounds.

As with Spreadcoin, the players 502-507 may be implemented using any appropriate combination of computer hardware and software. In an embodiment herein, the players 502-507 are implemented using computer workstations, although other implementations are possible, including one or more of the the players 502-507 being data sites containing multiple computers/processors, storage, etc. Some or all of the players 502-507 may be physically co-located or located in different physical locations. The system described herein allows the players 502-507 to conduct financial transactions without the need to be in the same location or the need to rely on a central authority by communication between the players 502-507 (and possibly others) through the network 508.

Democracy and Budget Balance. Note that Democoin is very democratic in spirit. By choosing a set of potential verifiers to coincide with the set of all users, and by selecting, at every round, the actual verifiers at random among all possible users, everyone has a chance to serve as a verifier. This is similar to what happens in other civic tasks, like jury duty. Moreover, by choosing carefully the ratio of actual verifiers and all users (e.g., 1/1,000), every user will actually become a verifier quite a few times each year. Note that acting as an actual verifier is not much of a burden. Indeed, the verification procedure is quite automatic and can be carried out in the back ground, by a computer or cell phone of a user, without troubling the user at all. In addition, an actual verifier is monetarily incentivized to properly verify all the payments submitted to the verifier in a round. For example, the actual verifiers may be rewarded with 1% of the total amount of payments that is validated. Note that this aspect of Democoin is quite different, and in a more democratic direction, with what happens in a traditional system. For instance, in a credit-card system, the users (e.g., the merchants) must pay 2% or 3% to the money paid to them to outside entities responsible to oversee the validity of the payments. By contrast, in Democoin, the users pay 1% of the money transferred to each other, and any one of the users has a chance of becoming an actual verifier at every round. For example, if the reward due to the verifiers for a given payment comes from the payee, and a user receives on average the same amount of money, then, in expectation, no user in Democoin looses any money due to the system rewards.

Security. If the same set of initially honest people are always “in power”, the temptation of colluding may become too strong to resist. This, however, is not the case in Democoin. First, as discussed elsewhere herein, an actual verifier cannot fake a payment by another player (because the actual verifier does not know the private key of the player). Second, an actual verifier cannot declare valid an invalid payment with impunity. In fact, a declaration of a verifier is digitally signed, and so are all payments, valid or not. Thus by declaring valid an invalid payment, a verifier must produce digitally signed and public evidence of his own guilt. Third, honest behavior of an actual verifier i at a round t is financially rewarded, and so it is not in the interest of the verifier to omit a valid payment from PAYₜⁱ. Fourth, the system relies on the opinion of a given majority of the verifiers, and as long as, for example 80% of all users are always honest, by selecting sufficiently many verifiers (e.g., 100) at each round, one is guaranteed that, with very high probability, the majority of the actual verifiers of a given round are honest. Finally, the set AV of the actual verifiers of a given round is randomly selected and becomes known at the start of the round. Thus, it is essentially useless for a dishonest verifier, upon learning the identity of the other members of AC, to try to convince the other members to collude with the dishonest verifier. The members of AC will not have the time needed to conspire; after, for example, just 10 minutes, a different random set of actual verifiers will be in charge to process the payments of the next round.

One may try to subvert the Democoin system by packing the set of potential verifier keys with public keys of malicious actors. Several ways exist, however, to protect against this potential attack. One way is to elicit an entry fee, or a (pro-rated) yearly fee from each public key in the system. Such a fee could be paid outside the system or within the system (e.g., via an automatic payment from each public key to a given key—or some given keys—in the system). This way, packing the set of public keys with artificially numerous and potentially controllable keys would be very costly.

A second way is having the probability of selecting a public key PK to become an actual verifier key at some round t depend also on the amount of money that PK as at, for example, the start of the round, that is, on the second field of the item (PK, #A, I) in STATUSₜ₋₁. This way ensures that a user does not get an advantage by having many public keys in the system for being selected as an actual verifier, because the probability of being so selected solely depends on the total amount of money the user has associated to all his public keys. The user thus may get the same probability by “keeping all his money in the system associate to a single key.” Note that this way users who are more heavily invested in the system also have more responsibility in running it (perhaps a virtue from some points of view).

A third way is having at least one special entity, deemed the verifier registration authority(s) (VRA), who certifies (anonymously or not) the public keys eligible to be selected as verifier keys. In this case, the VRA may easily ensure that each user has at most one key PK that can become a verifier key. This way, it becomes harder to pack the potential verifier keys with easily controllable keys. For instance, the VRA may ask a registrant to provide a proof of identity (and possibly insert some indication of the identity) in the certificate for the public key PK. Alternatively, the VRA could, from time to time, authenticate a single list of public keys eligible to become verifier keys.

Note that, when the number of players is large, if some of the above ways are adopted, subverting Democoin by controlling the majority of the potential verifier keys is very hard. (Much easier would be to subvert Bitcoin by controlling the set of miners, which already belong to a few consortia—“mining pools”—anyway.) Finally, another possibility is to have a mixture of verifiers: for example: (a) a fixed set of verifiers (possibly none); (b) a set of dynamically selected verifiers (possibly none); and (3) a set of registered over-time verifiers (possibly none).

### Sample Implementations of Selection Process

Target Number of Actual Verifiers. As an example, but without any limitation intended, let k denote a target number of actual verifiers at a given round. The target number may be fixed or change from round to round, and may be approximate. For instance, k may depend on quantities such as the (possibly approximate) round number, the (possibly approximate) total amount of money in the system, the (possibly approximate) total number of users/public keys in the system, etc. For instance, the system may have 100 verifiers when the number of users, or the number of public keys, is around 100,000. Using approximate numbers in such dependency may be usefull to make it clear what the target number of verifiers is even to those who are imperfectly informed (e.g., players who know only the system status of a few rounds before the current one).

Communications with Actual Verifiers. As with the verifiers of Spreadcoin, the actual verifiers of a round t of Democoin receive and send information. For instance, an actual verifier i needs to receive the payments of round t, and communicate PAYₜⁱ and possibly STATUSₜⁱ, both computed by Verifier i. Communicating with a few, fixed number of verifiers may be trivial, because, for example, the network addresses of the verifiers may be publicly known. However, when a set of potential verifiers is very large, and when the set grows with time (as when the set of verifier keys consists of the set of all public keys in the system), determining how to communicate to a just selected verifier may be somewhat inconvenient. Learning the composition of AV is one thing, and knowing how to communicating to the members of AV is another. To facilitate such communication it is possible to use an intermediary entity E who is in a better position to know how to reach each potential verifier. For instance, a user may send a given round t payment P to E, who then forwards P to each actual round-t verifier i. Also, each actual verifier i may post in a widely available website PAYₜ or STATUSₜⁱ computed by verifier i, and a user can then retrieve the posted information from the website, and verify authenticity of the information after the user learns the identity of the actual verifiers.

Alternatively, as discussed elsewhere herein, each record in STATUSₜ₋₁ consists of a tuple of the form (PK, #A, I), and thus the owner of PK might choose to include in the information field I information relative to how to communicating with the owner of PK: for instance, the url at which PAYₜⁱ and STATUSₜⁱ can be found whenever PK becomes the key of verifier i. Also note that the information field I can also be used to indicate if PK is eligible to be selected as a verifier key.

Initial Implementations. The set AV at a given round t can be derived form PV in a pre-determined manner from a random value vₜ associated to the round t. In particular, when vₜ may be a natural and public random value, meaning that vₜ is the widely available result of a random process that is hardly controllable by any given individual. For instance, vₜ may consist of the temperatures of various cities at a given time (e.g., at the start of round t, or at a given time of the previous round), or the numbers of stocks of given security traded at a given time at a given stock exchange, and so on, or a combination of such quantities q₁, . . . , qₘ, or a combination of such quantities and other quantities of the system, such as the current round t. For instance vₜ=H(q₁, . . . , qₘ), or vₜ=H(t, q₁, . . . , qₘ), or vₜ is the concatenation of H(t, q₁, . . . ,qₘ, 1), H(t, q₁, . . . , qₘ, 2) . . . , H(t, q₁, . . . , qₘ, s), where H is a collision-resistant hash function.

One way to derive AV from vₜ in a pre-determined manner is the following: Consider vₜ as a string of bits and let PV consist of a sequence of 2ⁿ potential verifiers, then the first log n bits of vₜ specify the first verifier (by specifying his corresponding number in the the sequence PV), the second log n bits specify the second verifier, and so on. Note that, in the above way, anyone who knows vₜ will end up selecting the same set of actual verifiers AV, and that AV will be randomly selected from PV because vₜ is random. Also note that the above way chooses a number of verifiers that is approximately k, since some verifier may be chosen twice, as for some i and j, the ith and jth log n-bit of vₜ may be the same. For instance, if one aims at selecting at random 100 actual verifiers from 100,000 potential verifiers, then it is possible to end up with just 96 verifiers, but this would be good enough. The probability of ending up selecting very few verifiers would be extremely small.

A more general way to derive AV from vₜ includes the steps of (1) obtaining in a pseudo-random manner a string R from vₜ—e.g., letting R=PRG(vₜ), where PRG is a psudo-random generator—and then (2) deriving AV from R (and/or PV). For instance, letting H be a collision-resilient or one-way hash function, R can be generated from vₜ by concatenating the following, for example, j strings: H(1, vₜ), H(2, vₜ), . . . , H(j, vₜ). This way, the random value vₜ could be short, even though one needs a longer string R to derive AV.

Additional Implementations. An alternative approach to select AV from PV involves one or more distinguished entities, referred to as trustees. If there were a trusted party T, T, acting as the single trustee, may randomly choose the actual verifiers V₁, . . . , Vₖ of a round t, and make the set AV clear to all, preferably in authenticated form, at a prescribed time (e.g., slightly before or at the start of the round). For instance, T may post or cause to have posted, SIG_{T}(AV) in a widely accessible website. This makes it clear who actual verifier of a given round are.

In a less direct, but still very clear way, T may choose a random value vₜ, from which AV is derived in a pre-determined manner (possibly by first producing a string R from vₜ, and then AV from R), and make vₜ widely available, preferably in an authenticated manner. For instance, T may post SIG_{T}(vₜ) in a proper website, so as to enable others to retrieve vₜ and then derive AV from vₜ in a pre-determined manner.

If T is not trusted, however, vₜ may not be be selected at random, and thus the actual verifiers may not be randomly selected. To avoid this problem, the value vₜ may be taken to be a natural public random value associated to the round t. For instance, if T publicizes SIG_{T}(vₜ), then everyone immediately learns what vₜ is, and thus immediately computes AV, and then can check whether the vₜ was indeed correct, by checking whether the agreed random process indeed produced vₜ. For instance, vₜ may be produced by checking what the number of stocks of a given security traded at a given time in a given stock exchange was. Accordingly, T need not be trusted much. By acting dishonestly T publicly incriminates himself by producing his own digital signature of the wrong value. Should this happened, T can be punished or fined, and the player who reports T's misbehavior may be rewarded. This system may work well when it is easier for at least some user to learn the value SIG_{T}(vₜ) from a given website than to ascertain the actual value of vₜ.

Alternatively, vₜ may be produced by T in a way that does not enable T to have full control on the actual value of vₜ. For instance, vₜ may consist of SIG_{T}(t), that is, vₜ may consist of the digital signature of T for the current round t, or of SIG_{T}(t, I), or of SIG_{T}(I), where I is some easy to determine information (including no information), and the underlying signature scheme used by T is deterministic. In fact, the digital signature of T may be de facto unpredictable to anyone but T, because only T knows the secret signing key associated to the public verification key of T, and thus, in particular, vₜ=SIG_{T}(t) is sufficiently random, and also sufficiently authenticated. More generally, when the information I is not controllable or cannot be influenced by T and vₜ=SIG_{T}(I), T cannot “shop around” for the vₜ that T wants, and thus, since AV is derived from vₜ in a pre-determined manner, T cannot shop around for the set of actual verifiers AV that T wants.

The mechanism discussed above, however, leaves open some possible cheating from a malicious T. Assume for simplicity that vₜ=SIG_{T}(t). Then, T can compute his own digital signature of some future round t. Accordingly, although T may not be able to chose a AV as T pleases, T may: (a) realize what value AV will take in the future, (b) realize the players that will be the verifiers of future rounds, and (c) alert a set of players that they will indeed be the verifiers of a given future round. If this is the case, the verifiers of some future round t may be given plenty of time (rather then just—say—10 minutes) to collude with each other. To protect against this possibility, it may be better to chose vₜ=SIG_{T}(t, I), ensuring that I includes the result of a random process at a time t, or close to t.

Further Implementations. Another alternative is to rely on multiple parties, T₁, . . . Tⱼ, trusting that at least one of them is honest. After each party T computes a value vₜⁱ, in any one of the ways described above, the value vₜ could be taken to be a predetermined combination of various values vₜⁱ (possibly with some additional information I ). Note that it is still possible for one party Tᵢ to be able to control arbitrarily the final value vₜ, even when all values vₜ^{x}, for x≠i, have already become known. For instance, assume that each party Tᵢ is allowed to choose vₜⁱ without any constraint, and that the final vₜ is the sum, modulo some large integer N, of all vₜ^{j}. Then if party Tᵢ announces his own value vₜⁱ after Tᵢ learns the values announced by all other parties, then Tᵢ can choose vₜⁱ so as to force vₜ to be any value mod N Tᵢ wants. Preferably, a combination of multiple parties will prevent one party Tᵢ from being be able to control arbitrarily the final value vₜ, even when all values vₜ^{x}, for x≠i, have already become known. For instance, if vₜⁱ=SIGᵢ(t) for all i, then one can let vₜ=H(vₜ¹, . . . , vₜ^{j}, I), where H is a collision-free hash function.

Notice, however, that one the Tᵢ's might be unable, at some round t, to produce a (properly authenticated) value vₜⁱ. For instance, Tᵢ's computer may not be working, or Tᵢ may be disconnected from the network, or otherwise unable to convey vₜⁱ. When this is the case, the combined value vₜ, and thus the derived set of actual verifiers, may not be able to be computed. To prevent this possibility, each vₜ could be produced so that not only it is sufficiently random and easy to verify, but also robust, in that, as long as a majority of the Tᵢ's function properly, it is also easily and always computable and verifiably unique. For instance, it is possible to use multi-party secure computation, or threshold signatures, in order to produce and publicize a public verification key PK of a given deterministic digital signature scheme, and ensure that each party Tᵢ knows a “piece” of the matching secret signing key SK. This way, letting for example (but without limitation) vₜ=SIG_{PK}(t, I), it is possible ensure that, for all λ<j: (1) vₜ can be easily computed with the help of any λ+1 parties Tᵢ's, and (2) vₜ is essentially unpredictable to any λ or less of the parties Tᵢ's. This way, as long as more than λ of the above parties are honest/work properly, every one will correct learn vₜ, and vₜwill continue to be unpredictable until round t (or at around round t).

Verifiers preferably authenticate information about payments via digital signatures using public keys of the verifiers, which are identified with owners of the public keys. It is possible to select, at a round t, a random set of actual verifier keys, AV, from a set of potential verifier keys, PV. When PV and vₜ are common knowledge (e.g., when the set PV is fixed), all users can derive the same random set AV, or close sets, of actual verifiers. For instance, AV can be taken to be the subset of PV determined by H(PV, vₜ), where H is a collision-resilient hash function. However, it may be more complex when PV is not common knowledge, and different users may have different ideas of what PV is. For instance assume that PV at a round t is taken to consist of all public keys currently in the system (or all public keys appearing in the STATUSₜ₋₁, or all public keys in in STATUSₜ₋₁ identified as potential verifier keys). Then, PV may continue to grow over time, as new keys are continually added to the system. At the same time, letting t be the current round, a user U₁(e.g., because U₁ could not monitor the system for a while) may only know the status of the system of “5 round ago”, STATUSₜ₋₅, while another user U₂ knows STATUSₜ₋₁. Accordingly, U₁ may believe that the set of potential verifier keys is PV₁, while U₂ may believe that the set of potential verifier keys is PV₂, where PV₂ contains, for example, 1% more keys than PV₁. Then, even though PV₁ and PV₂ essentially coincide, the bits in H(PV₁, vₜ) and H(PV₂, vₜ) may be different in 50% of the positions, because a collision-resilient function H is sensitive to each bit. Thus, the set of actual verifier keys according to the two users, AV₁ and AV₂, may be dramatically different, so that the majority opinion in AV₁ has very little to do with the majority opinion in AV₂. This possibility is avoided, as discussed elsewhere herein, by choosing a selection procedure that, properly carried out by different users, produces random sets of actual verifiers that are close to each other.

For example, a robust selection procedure may assume, without loss of generality, that PV consists of all public key in the system H may be a (preferably collision-resilient) hash function, and PK a public key in the system. PK may become a verifier key at round t if and only if, for some given number p between 0 and 1, the following is true:

.H(PK, vₜ)≦p

Assume, without loss of generality, that H's outputs are 256-bits long. Then H(PK, vₜ) de facto is a random 256-bit number. Thus, putting a decimal point in front of this number, it is possible to interpret “.H(PK, vₜ)” as a binary expansion of a 256-bit random number between 0 and 1, and thus let PK become a verifier key if and only if the result of evaluating .H(PK, vₜ) is less than (or equal to) p, which will happen with probability p. If it is desirable that one in one thousand keys become an actual verifier key at round t, then p may be set equal to 1/1,000. In such a case, if there are 100,000 public keys in STATUSₜ₋₁, then it is expected that 100 of the keys will be determined to be actual verifier keys. Assume that STATUSₜ₋₁ is known to a second user, while a first user only knows the status of 4 rounds before, where 1,000 less keys were present. Then, the expected number of verifier keys is 99 for the first user, and 100 for the second user. In any case, the set of verifier keys essentially coincide for both users. In fact, if a key PK appears in STATUSₜ₋₄, the key PK also appears in STATUSₜ₋₁. Moreover, if PK is a verifier key according to the first user, then .H(PK, vₜ)≦p, and thus PK also is also a verifier key according to the second user, because the values vₜ and p are the same in both cases (for both users), and so is the result of comparing .H(PK, vₜ) and p. In sum, the verifier keys according to the second user coincide with those according to the second user, except that it is expected the latter to consider one more key to be a verifier key. Assume now that a payment P is valid if it is deemed valid by 51% of the actual verifiers. Then, if 80% of actual verifiers according to the second user act honestly and authenticate P as valid, then with high probability, at least 51% of the actual verifiers according to the first user will also authenticate P as valid. And vice versa. The above described verifier selection procedure is thus robust. In other words, despite the lack of synchrony and centralization, and despite the verifiers changing completely at each round, the verifier selection mechanism described above guarantees a remarkably accurate consensus in a very efficient manner.

### Updates

Ideally, at each round t and for each round-t actual verifier j, every potential verifier i and every potential user i in the system may obtain (e.g., download) authenticated lists PAYₜ^{j}, and possibly STATUSₜ^{j}. In this case, in fact, each user i knows/can easily compute STATUSₜ for each round t. Alternatively, if PAYₜ and STATUSₜ are made directly available (e.g., computed and posted by one or more given entities, preferably in an authenticated manner), then a potential verifier j or a user i trivially obtains PAYₜ and STATUSₜ at each round i. As explained below, it is sufficient for a verifier j or a user i to obtain the Status of the system only once in a while.

For concreteness, but without any limitation intended, assume that PV consists of all public keys in the system, that AV is computed using a robust selection procedure such as the mechanism discussed above, that a potential verifier j obtains status of the system once a month, and that suddenly, at round t, the verifier j is selected to become a verifier, that is, that the public key PKⱼ of the verifier j is in included in AV. Notice that to realize that PKⱼ becomes a member of AV at round t, the verifier j need not know any global status information, but only vₜ. Indeed, PKⱼ is included in AV if and only if H(PKⱼ, vₜ)≦p.)

To perform as an actual verifier, and receive the corresponding reward, the verifier j needs to know STATUSₜ₋₁. If a facilitator E, were available, then the verifier j could immediately retrieve STATUSₜ₋₁ (e.g., by downloading SIG_{E}(STATUSₜ₋₁) the moment PKⱼ is selected. In absence of any facilitators, the verifier j could immediately retrieve the published and authenticated lists STATUSⁱₜ₋₁, for sufficiently many verifiers j of round t−1. To do this, however, the verifier j needs to determine what the verifier keys of rounds t−1 were.

Since each potential verifier key PK is chosen at round t−1 if .H(PK, vₜ₋₁)≦p, to make the determination the verifier j needs to know two pieces of information: (a) all public keys in STATUSₜ₋₁ and (b) the value vₜ₋₁. Note there is no problem for the verifier j to obtain the latter piece of information, because by definition the value vₜ₋₁ was made widely available, preferably in authenticated form. As for the piece of information (a), the verifier j can compute information (a) with sufficient precision from the Status information of a month ago held by the verifier j. For instance, assume that the number of potential verifier keys grows at the rate of 20%/year, and that there were 500,000 such keys a month before, when the verifier j obtained the full status-list of the system. Then, roughly 10,000 new potential verifier keys have been added in the last month without knowledge of the verifier j. Assume that the selection probability p was such that 101 verifiers were individually and randomly selected at round t−1. Then, the probability that one of the newly added 10,000 keys is actually selected as a verifier key is 0.0002. (Note, by the way, that the probability that one the the new 10,000 keys is selected when the target number of verifiers is 11, would be even lower: namely, 0.00002.) In any event, the set of actual verifiers of round t computed by the verifier j according to the one-month-old record, coincides, with high probability, with the true list of verifiers of round t, computed based on all potential verifier keys of round t−1. Moreover, with overwhelming probability, the number of actual verifiers selected from the newly added 10,000 keys will be very few. Accordingly, when a reasonable majority of the potential verifiers are transparent, with overwhelming probability, the majority of both sets of verifiers (i.e., the actual verifiers, and the verifiers according to one-month-old data of the verifier j) will be transparent. In sum, even if the verifier j obtains the full list of potential verifier keys once a month, after being selected, the verifier j would be ready to perform the verification functions accurately.

Alternatively, rather than obtaining the full status once a month, a potential verifier j could obtain once a month just PAYₜ^{j} of the last 30 days, from which (given the previously computed full status information of a month ago held by the verifier j) the verifier j can easily reconstruct the current status information. Furthermore, if tree-hash-and-sign method is used (see discussion below), the verifier j could easily check that the reconstructed status is correct by simply (i) locally computing the alleged root hash of the tree for round t−1, and (ii) verifying that each verifier authenticated the same root hash at round t−1.

Alternatively yet, in order to facilitate updates, each selected verifier j of a given round t, in addition to PAYₜ^{j} and STATUSₜ^{j}, could also authenticate and publish NEWₜ^{j}, the list of newly added potential verifier keys at round t. Notice that, by so doing, the verifier j remains fully accountable for all the data published by the verifier j.

A player i without verifying responsibilities may only care about whether a given payment P made to player i is valid. Such a player can certainly perform monthly updates as a potential verifier. However, with no rewards and no liabilities, the player i may be satisfied with a much lighter check of the validity of P. For instance, if a facilitator is present, and tree-hash-and-sign is used, then the player i may obtain only the facilitator-authenticated information that enables the player i to determine whether P is a valid payment. Alternatively, if the player i obtains full status information once a month, then the player i may use one month-old information about the set of potential verifiers, and the new public value vₜ of round t, in order to compute only one alleged verifier j for round t; and obtain and verify only the compact j-authenticated record of payment P (assuming again that tree-hash-and-sign is used).

### Using Certificates in Democoin

Centralcoin, Spreadcoin and Democoin can be used (a) as a separate (and separate floating) digital currency, or (b) be tied to (and floating with) a national currency, or (c) both; and certificates can be effectively used in all three payment systems.

In particular, a distinguished entity D, possibly belonging to a set or multiple entities, can be used to certify a public key PK_{X} of an ordinary user X, or of a verifier X, or a potential verifier X, or a facilitator X, etc.

Since the public key PK of a distinguished entity D can be widely known in the system (e.g., because PK was certified via a public key universally known in the system), the certificates issued by D, and thus the public keys PK_{X} certified by D, can be widely verified/recognized in the system. The certificates issued by D may be recognized by all or nearly all of the potential verifiers or by at least a significant number of the potential verifiers (i.e., enough to allow a given majority to validate payments made by a player using a public key certified by D). Entity D may produce certificates for all kinds of players/public keys, or for some class of players/public keys. For instance, D may certify the public keys of ordinary users, but not, for example, public keys of verifiers or potential verifiers (which may be certified by another distinguished entity). In particular, D may be a bank (or other financial institution), and may certify the public keys of customers of the bank, X.

As discussed elsewhere herein, a certificate C issued by D for a public key PK_{X} may be of the form

C=SIG_{D}(PK_{X}, I),

where I is some arbitrary information, including no information. For instance, I may include:
Identity information about the issuer D.
Identity information about public key owner X.
qualifying information Q, specifying whether PK_{X} is an ordinary-user public key, a potential-verifier public key, a facilitator etc.;
time information t, such as the time the certificate has been issued, or the expiration date of the certificate, or both;
monetary information. For instance, the initial amount of money associated to PK_{X};
territorial information, specifying the territory where PK_{X} is allowed to operate; and/or
possible restrictions on the transactions PK_{X} is allowed to do (e.g., restrictions to make money transfers to some public keys or classes of public keys.

To issue C, D may take or have some other entity take one or more of the following actions:
Checking the correctness of at least some of the information I.
Checking X's willingness to have PK_{X} certified in the system. In particular, D may obtain and keep a proof of such willingness of X that can be produced, at the same time, or at a later time, to another entity, such as a government or other regulatory body. Such proof may include an executed declaration that X (e.g., by a traditional signature, or by a digital signature, possibly relative to another public key of X). Such a proof may be included in the certificate itself. For instance, if needed, after it has been digitized.
Checking that X knows the secret signing key associated to PK_{X}. For instance, D may require X to solve a challenge that requires knowledge of SK_{X}. In particular, X may be required to digitally sign a given message relative to PK, such as the current date, a message chosen (preferably at random) by D, a message indicating X's willingness to have PK certified. Such a proof of knowledge of SK may be included in the certificate. Alternatively, a collision-free hash of such a proof can be included in the certificate, and D may be required to keep the original proof, and to produce it in case—say—of an audit/inspection.
Helping X to obtain PK_{X};
Choosing/assign PK_{X} for/to X, preferably ensuring that only X knows the corresponding secret key SK_{X}.
Checking that the corresponding key SK_{X} has been escrowed.
Giving an initial amount of money to PK_{X}.
Identifying X;
Safe keeping information useful to identify X (e.g., escrowing the information).
Checking that X is eligible to have PK_{X} certified. For instance, D may check that X has clean criminal record, that is not listed to belong to a terrorist organization.

When ordinary-user public keys are certified, to verify that a payment P by a given public key PK₁ to another public key PK₂ is valid, in addition to all other checks already discussed, preferably one should also check that both keys have valid certificates issued by a proper entity. To enable the verification of such a payment, one (e.g., the payer or the payee) may also provide a proper certificate C₁ for PK₁, and a proper certificate C₂ for PK₂. In fact, it may be assumed that, when keys are certified, any payment P by public key PK₁ to public key PK₂ also includes C₁ and C₂.

### Using Certificates for Verifiers

Of particular interest is the case when D is authorized to certify public keys of verifiers or potential verifiers. To issue a certificate C identifying PK_{X} as a verifier (or potential verifier) public key, D may check that player X is indeed eligible to be a verifier and does not possess another verifier public key. Alternatively, D may check that D has not personally certified another verifier key for X. When verifier keys are certified, to verify the digital signature s relative to a verifier key PK_{V}, preferably one should also verify that PK_{V} has a valid certificate issued by a proper entity.

### Using Certificates Against Illegal Activities

The payer and the payee of a payment made via check are readily identifiable. Accordingly, the check payment system is rarely used for money laundering or other illegal activities. It may be desirable that the same holds for the systems described herein. For this purpose, it may be desirable that a special entity S (e.g., a governmental entity, the police, or a judicial entity) be able to trace a public key PK_{X} to an owner X of PK_{X}. To this end, certificates can be very useful. If PK_{X} is certified by a distinguished entity D, e.g., C=SIG_{D}(PK_{X}, I), then D may be required to keep and to provide to S, upon proper request, the identity of X.

Alternatively, the information I in C may contain information I_{X} enabling an easier identification of X, in particular I_{X} may consist of the name of X. This way, however, makes PK_{X} easily traceable to X by many more people than just S, D, and a few other entities.

Another solution is to have I_{X}=H(i), where i identifying information for X (e.g., X itself) and H is a collision free hash function. This way, an entity that does not know X or does correctly guess who X is, cannot trace PK_{X} to X. On the other hand, if D has correctly issued C, D cannot later on lie about the identity of X, and in case of an audit may trivially hand X to S, who can then hash i and compare the result with I_{X}.

Another solution is to have I_{X} be an index to a table (or similar data structure) used to retrieve a value that identifies X (e.g., the name of X). The table may be held by D, by S, and/or by some other entity. In case of an audit, the entity having the table would be presented with I_{X} and would produce the identity of X in response.

Another solution consists of having I_{X}=Enc(i), that is, having I_{X} consist of an encryption of i with a key of D. This way, if Enc is a sufficiently secure randomized encryption scheme, then even someone correctly guessing who X is cannot use I_{X} to confirm the correctness of the guess. In case of an audit, D may also provide the random string used to produce Enc(i). However, S would still have to contact D in order to know who X is.

To avoid interacting with D, Enc(i) may be an encryption of i in a key of S, e.g. an encryption key shared by D and S, or a public encryption key of S, for which S, and preferably only S, knows the corresponding secret decryption key. Public key encryption is well known. This way S may automatically and directly trace PK_{X} to X, and thus every payment to a particular payer and payee, very much as for check payment. However, while paying via a check makes the payer and the payee readily clear to anyone holding the check, the same is not true for the system described above.

### Rewards

The entity D issuing a certificate C=SIG_{D}(PK_{X}, I) may be rewarded in a number of ways. For instance, D may be paid by X for producing C. Also, D may receive a reward for each valid payment P (e.g., a reward of 0.1% of the amount A of P) if the payer/the payee key of P is certified by D. For instance, such a reward may be paid to D by the payee (or the payer), if the payee key of P is certified by D. As for another example, if rewards are paid only by retailers, and if the payee key of P is a retailer key certified by D, then the reward due to D for P is paid to D by the retailer. Rewards may be paid using the system described herein. For instance, if a public key of D can have money associated to the public key, or if D has another public key capable to have money associated to the public key, then D's reward may be a payment from the relevant public key of P (e.g., the payer or the payee key of P) to the relevant public key of D. Such payment to D can occur automatically, as discussed elsewhere herein. For instance, the reward may be paid when P becomes part of PAYₜ at some round t. The reward to D can also be made outside the system. For instance, if D is a bank, the reward to D for a payment P may include a payment from the payee X in P to D, and if X has a bank account with D, then when P enters PAYₜ, D is authorized to withdraw the reward from the account of X.

### Scalability

Democoin is very scalable, particularly with the help of a properly designed architecture for information flow. This is described below in connection with three sample instantiations referred to as “Urban”, “Regional”, and “National” that differ in the envisaged number of users and transactions. In all the examples, it is assumed that
(a) A round consists of 10 minutes. Note that this is the time it takes Bitcoin to generate a new block. However, as discussed above, one would have to wait for three blocks to be generated before have some confidence that one transaction in the third last block will enter the definite transaction history. By contrast, in Democoin, a definite status report is reached after each round.
(b) A single authenticated payment (or status report record) is about 100 Bytes. Indeed, 100 Bytes are sufficient to include large amount of auxiliary information.
(c) A player can efficiently retrieve information about other players necessary for communication. (e.g., via registry or an IRC channel with players' public keys and IP-addresses information).
(d) Anyone can efficiently retrieve information from a storage provider, such as the cloud. (e.g., Amazon Cloud acts as a post-facilitator.) Note that, in all the sample instantiations discussed herein, the cloud (i.e., the post-facilitator) is NOT a trusted central authority. Indeed, the cloud cannot fake a payment on behalf of a user, cannot maliciously alter how much money a given public key holds, nor selectively remove from the full status report the information about some players, so as to de facto deprive the players of the use of money. In fact, a verifier generates a status report by digitally signing together the money currently held by all public keys. Thus, the cloud may at most refuse to post an entire status report, but not pick and choose which public keys will appear in the report. Should this indeed happen in some round, then no money changes hands in that round, and a new cloud provider may be used. Moreover, even this problem can be mitigated by relying on multiple clouds: for instance, Amazon Cloud and Google Cloud.

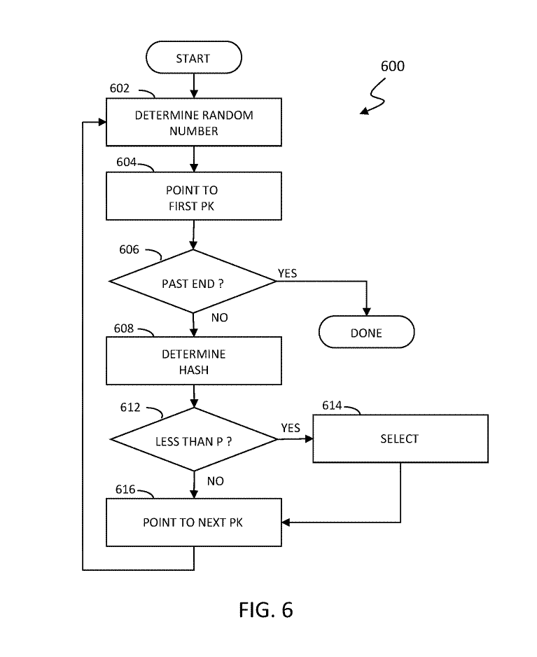

Referring to FIG. 6, a flow diagram 600 illustrates steps performed in connection with determining which of the players will be verifiers in a particular round. processing begins at a first step 602 where a random number is determined, as described elsewhere herein. Following the step 602 is a step 604 where an iteration pointer, that iterates through all of the players, is set to point to the first player in a list. Following the step 604 is a test step 606 where it is determined if the pointer points past the end (i.e., all the players have been processed). If so, then processing is complete. Otherwise, control transfers from the test step 606 to a step 608 where the random number and the PK associated with the player are hashed, as described elsewhere herein. Following the step 608 is a test step 612 where it is determined if the result from the step 608 is less than some value p. If so, then control transfers from the test step 612 to a step 614 where the player corresponding to the iteration pointer is selected as a verifier. Following the step 614 or following the step 612 if the result from the step 608 is not less than some value p is a step 616 where the iteration pointer that iterates through all of the players is incremented. Following the step 616, control transfers back to the step 606 for another iteration.

Below are four criteria for analyzing the scalability of Democoin:

Network Bandwidth: the bytes per second/month a player should be able to transfer. Note that several cell-phone or Internet providers cap the total number of data that a user can exchange in a month.

Connection Capacity: the maximum number of simultaneous connections a player can have.

Storage and Computation: the resources needed for a user to participate in the system.

### The Urban Instantiation

The Urban Instantiation is defined to have 300,000 users and 1,000 transactions every 10 minutes. Thus, in the Urban Instantiation, users and transactions numbers are slightly larger than those in the current usage of Bitcoin.

Since a single payment consists of 100 Bytes, the approximate size of the corresponding PAY report is only 100 KB, the size of a full status report is about 30 MB, and (using tree-hash-and-sign mechanism, described below) the size of a self-sufficient authenticating record for a single public key is about 2 KB. Altogether, these are very reasonable sizes (and a 30 MB status report is certainly preferable to a 15 GB public ledger in Bitcoin).

To reduce network bandwidth, connection capacity, and storage it is possible to provide a simple, generalizable, and effective information flow, as described below:

At each round t, there may be 110 verifiers (chosen as before), organized in a two-level, 11-node tree: a root with 10 children (and thus 10 leaves in this case). The root may be regarded as having level 1, and each leaf as having level 2. The verifiers may be partitioned in 11 groups/buckets of cardinality 10 each. Each group may be conceptually assigned to a separate node in the tree. The 10 verifiers assigned to the root may be deemed top verifiers and to the other 100 verifiers may be deemed helper verifiers.

The information flow is as follows: At the beginning of the round, the top verifiers obtain the full status report of the previous round, that is, STATUSₜ₋₁. Since the status consists of a 30 MB, the top verifiers can obtain the full status report even with a cell phone.

There is a preferred information flow for each of the 1000 payments of round t. Consider a payment from a (payer) public key Pᵢ to a (payee) public key Pⱼ. Then, since a tree-hash-and-sign algorithm is being used, (the owner of) Pᵢ retrieves from the cloud the 2 KB proving the individual status of Pᵢ and forwards the proof to (the owner of) Pⱼ together with a 100-Byte payment from Pᵢ; (the owner of) Pⱼ preferably verifies both pieces of information and forwards the information to each of the 10 helper verifiers in a bucket associated to one of the 10 leafs. That is, the payee selects a bucket B and forwards the relevant payment and individual status to each verifier in B. Note that all other information flows that convey the essential information should be considered part of the architecture of the system described herein. For instance, the payer may only send the payment to Pⱼ; while Pⱼ obtains from the cloud the individual status of PKᵢ, and forwards the individual status of PKᵢ and the payment to the helper verifiers of the selected group. Alternatively yet, the payee may only forward the payment to the helper verifiers, who then obtain the individual status of PKᵢ of the previous round from the clouds. Of course, other possibilities/combinations exist.

Note that the computation involved so far is trivial: (the owner of) Pᵢ generates one digital signature; while (the owner of) Pⱼ verifies one digital signature and computes one hash to select the bucket B. Also, the bandwidth is relatively low: (the owner of) Pᵢ obtains 2K bytes from the cloud and forwards 2.1K bytes to Pⱼ; and (the owner of) Pⱼ forwards 2.1K bytes to each of the 10 helper verifiers in bucket B.

The bucket B may be selected at random. In particular, to ensure that lazy payees do not instead always select, for example, the first bucket, B can be selected via a given cryptographic hash function H. For instance, (the owner of) Pⱼ may hash the payment (possibly with additional information, such as vₜ) and use the last decimal digit of the hashed payment to determine which of the 10 possible buckets of help verifiers should be the selected B. In this case, a helper verifier in B, receiving and processing the payment information, may also use H to verify that the payment information was correctly sent to the bucket B to which the helper verifier belongs.

Since 1000 payments are distributed randomly across 10 buckets, each bucket of verifiers may be selected for approximately 100 payments. Accordingly, each helper verifier must be able to receive 2.1K bytes from approximately 100 users. Therefore, even via a standard cellphone a helper verifier can receive the data within 1 minute (even being capped at 10 simultaneous connections).

Each helper verifier checks that, for each payment being handled, all the relevant information is correct. That is, for each payment of #X from a public key Pᵢ to another public key Pⱼ, the helper checks that the digital signature of the payment, the digital signature(s) of individual status report of Pᵢ for the previous round, and that the amount X does not exceed the money attributed to Pᵢ in the report. Then, the helper preferably compiles all valid payments in a single, preferably ordered, list L, and digitally signs L together with an indication of the round t (e.g., the current time). Finally, the helper sends to each of the 10 top verifiers, the signed and dated list L, and preferably also the individual prior status of each paying public key.

To receive the information, each top verifier only need to open 100 connections to download countersigned payments. As mentioned elsewhere herein, even using a standard cell phone, this can be done within 1 minute. Note, that is may be tempting to store reports produced by the helper verifiers on the cloud and ask the top level verifiers to retrieve it from there. However, this is bad design decision since in this design the cloud may choose to deny a payment of an individual by erasing the corresponding reports from the helper verifiers. Each top verifier i uses the downloaded countersigned payments to produce the reports STATUSₜⁱ and PAYₜⁱ, and posts STATUSₜⁱ and PAYₜⁱ, on the cloud. The size of both of the reports is about 31 MB and can be uploaded to the cloud within 4 minutes by a cell phone. Additionally, the signed information received from the helper verifiers could be uploaded to the cloud, so as to keep everyone accountable.

It is possible to optimize the system described herein by uploading/downloading only self-contained records between the verifiers and the cloud. For instance, suppose at round t−1 all verifiers and the cloud hold up-to-date status report STATUSₜ₋₁. Suppose also that a top level verifier i wants to efficiently communicate STATUSₜⁱ to the cloud. Using a tree-hash-and-sign mechanism (described elsewhere herein), a hash of every record of the report corresponds to a leaf in the tree; and only the root of the tree needs to be signed by the verifier. There are at most 2000 record changes between STATUSₜ₋₁ and STATUSₜ, given 1000 payments. Hence, assuming the cloud knows STATUSₜ₋₁, to communicate STATUSₜ₋₁ⁱ, the verifier only needs to communicate the changes in the tree (that is, 2000 new records), and the signature of the new root. Given STATUSₜ₋₁ and the new records, the cloud can reconstruct the entire tree and obtain the hash of the root. The cloud then can use the signature of the hash obtained from the verifier to reconstruct the full version of STATUSⁱₜ. Using this mechanism, only approximately 210K bytes of data needs to be communicated between the verifiers and the cloud.

In sum, the Urban Instantiation can be run via a cell network with a network bandwidth and Capacity of 1 Mega-bit per second (Mb/s), capped by 2 GigaBytes (GB) per mont, and a connections Capacity of 10.

The Regional Instantiation.

The Regional Instantiation is defined to have 3,000,000 users and 10,000 transactions every 10 minutes. That is, in the Regional Instantiation, users and transactions numbers are 10 times higher than in the Urban Instantiation. The Regional Instantiation may be run via laptops.

For the Regional Instantiation, the total size of the status report is about 300 MB, that is, 10 times bigger than the report for the Urban Instantiation. Thanks to the tree-hash-and-sign mechanism (described elsewhere herein), however, the size of self-contained report about an individual public key is only 5K bytes. To maintain a good performance, it is possible to increase the number of helper verifiers by a factor of 10, so that the total number of verifiers, from 110, now becomes 1010. The verifiers may be partitioned in 101 groups (buckets) of 10, and conceptually each bucket may be assigned to a node of a 3-level 10-degree tree T. That is, the root of T has, as before, 10 children (of level 2), but now each of the children has 10 children (of level 3). The 10 verifiers assigned to the root are deemed top verifiers, and all other verifiers are helper verifiers.

There are now 100 buckets on the third level. Each payee (or payer) of a given current payment chooses at random (using a cryptographic hash function) which bucket will handle the payment. Therefore, on average, each level-3 helper verifier only handles 100 payments, which can be downloaded within a minute by a laptop computer. Once verified, the payments are forwarded to a bucket of level-2 helper verifiers (again, chosen at random). Similarly, each level-2 verifier needs to open only 10 connections and download 1000 payments, of size approximately 100 Kilobytes which can be done easily within a minute. After verifying and combining the information received from children buckets, and signing the combined information, each level-2 helper verifier sends the proper information to each of the top verifiers, that is, to each verifier in the group associated to the root, the only node of level 1. After verifying, combining, and signing all the received information, that is, after generating STATUSₜⁱ and PAYₜⁱ, each top verifier i uploads STATUSₜⁱ and PAYₜⁱ, to the cloud. This uploading could take about 4 minutes with a standard laptop. Thanks to the envisaged tree-hash-and sign method, each top verifier i can use the same “More Efficient Update” method, already discussed for the Urban Instantiation case, in order to dramatically cut down the amount of data to be uploaded, and thus the time of the uploading, without increasing at all the trust of the power of the cloud. Any player may update its state by querying the storage provider for relevant self-contained new records within a minute. The computational time needed from verifiers is also about a minute. Therefore, the expected duration of a round in this instantiation is approximately 8 minutes.

In sum, the Regional Instantiation can be run (within 10 minutes) with a network bandwidth and capacity of 10 Mb/s, capped by 80 GB per month, and a connections capacity of 10.

### The National Instantiation

The National Instantiation is defined to have 30M users and 100k transactions every 10 minutes. This scales the urban example by a factor of 100. If there are 30 million users and 100 thousand transactions every 10 minutes, the size of the status reports grows to 3 GB, but the size of self-contained authenticated individual record remains small—about 7 KB. It is also possible to add a 4th level of 1000 buckets of helper verifiers. Therefore, they are now an additional 10000 verifiers at the 4th level, each receiving about 100 payments for verification. All other parameters scale correspondingly and can be easily handled by a standard laptop. Moreover, the entire round can easily be performed within about 20 minutes using the efficient updates mechanism described in the Urban Instantiation (the communication overhead for 100K payments is insignificant, but the extra 10 minutes is added to account for the computational time to verify the payments.

### Even Larger Instantiations

Generalizing the architecture discussed above, it is possible to handle Continental and Planetary Instantiations, respectively capable of handling 300M and 3B users, and 10× and 100× as many transactions as the National Instantiation. The adoption of the More Efficient Updating is useful in such cases. The rounds may become longer, but feasibility will still be maintained.

Democoin is a democratic monetary system in that the responsibility of running Democoin resides with the users themselves. For efficiency reasons, however, Democoin is not run by all users simultaneously. Rather, at each round, only some users are randomly selected to act as verifiers, so as to guarantee the integrity of the system. The verifiers of a given round are rewarded for their effort and availability. Indeed, the verifiers stand to be collectively paid 1% of the total money that changes hands in a given round. No payment is made by the users to outside parties for running the system except for the payment due to the cloud for providing accessible storage. However, payment to the cloud is a negligible amount relative to amounts traditionally due to “trusted parties” to run a financial system, such as credit card issuers.

Democoin is fair. A verifier stands to make a lot of money, and, at every round, all users have the same probability of becoming verifiers. In addition, as explained below, each user in the three instantiations described elsewhere herein are extremely unlikely to never be selected to be a verifier. Assume that the total 1% reward of a given round is distributed equally among all verifiers (i.e., that top verifiers and helper verifier are treated alike). Then, because the ratio of total number of users and the total number of verifiers is roughly the same in the Urban, Regional, and National Instantiation, in all these instantiations the probability for a user to become a verifier is the same at every round. Moreover, because in the first two instantiations each round consists of 8 minutes, it can be easily seen that in the Urban and Regional Instantiation a player is expected to become a verifier about 22 times a year, that is, just under 2 times a month. Altogether this is a non-trivial frequency. This frequency can be increased by increasing the verifiers-to-users ratio. Note also that Democoin is fair in a difference sense when the probability of being selected is proportional to the money a user owns, possibly over different public keys.

Democoin also provides significant security. The system works as expected if the majority of the verifiers in every bucket are honest and execute correctly according to the system specifications. Suppose that 90% of the users are honest and hence a status report (or payment) is valid if and only if 90% or more of the verifiers validate the status report (or payment). If a 90% or greater consensus is not reached in a given round, then de facto no money has changed hands in that round. In this case, the probability that a randomly selected player is malicious is 0.1, and the probability that a randomly selected pair of players are malicious players is 0.1*0.1=0.01. Continuing this calculation, it is possible derive the probability that 9 or more chosen verifiers, at a given bucket, are malicious, which is equals to about 10⁻⁸. That is, given ten selected players in a bucket, the probability that one of them is not-malicious and the rest are malicious is 10*(0.9*0.1⁹). Accounting for the case when all chosen players are malicious which is 0.1¹⁰ and summing up the two probabilities, it is possible to obtain that from the selected 10 players, the probability that 9 or more are malicious is about 10⁻⁸.

In the Urban Instantiation scenario, there are 11 buckets of verifiers. Hence, the probability that one of the buckets is malicious is at most 1.1*10⁻⁷. Hence, every 9 million rounds, there is expected to be one bad selection of the verifiers. The 8 minute rounds result in about 65,744 rounds in a year. Hence, it is expected that there will be one bad selection of the verifiers once every 137 years, which is enough for practical instantiations on the Urban Instantiation scenario.

However, suppose the number of verifiers in each bucket is increased to 50 and suppose 80% of the verifiers are honest. Then, the probability that a single bucket of verifiers is malicious (that is, 40 or more of the selected verifiers are malicious), is about 1.3*10⁻¹⁹. This probability p can be derived using formula:

p=Σᵢ₌₁₀⁵⁰((ᵢ⁵⁰)*0.2ⁱ*0.8⁵⁰⁻ⁱ).

where 0.2 is the probability of selecting a malicious verifier, and 0.8 is the probability of selecting an honest verifier; and the sum is over all of the “bad” selections.

Given 11 buckets in the Urban Instantiation, the probability that one of them is malicious is at most 1.43*10⁻¹⁸, or once every 7*10¹⁷ rounds. That is, a bad occurrence is expected once every 10 trillion years. Moreover, in Regional and National Instantiations, the frequency reduces somewhat, but still remains astronomically high to approximately every 1 trillion years and 100 billion years, respectively. Moreover, note that in order to mount a successful attack, it is not enough that at least 40 of the 50 selected verifiers are malicious, but that these malicious verifiers succeed in coordinating their actions within a round, that is, in a few minutes. (Recall in fact that the set of verifiers of a future round t cannot be predicted long in advance, because it depends on a variable vₜ that is totally unpredictable until round t.) Since a round is very short, this coordination may not be practically feasible. Moreover, by slightly increasing the number of verifiers, it is possible to achieve virtually any level of security deemed useful.

Tree-Hashing

As discussed elsewhere herein, tree-hash-and-sign is an effective mechanism to authenticate a large list of records with a single signature, while supporting efficient “local” verification (without the need to download the entire list). This mechanism is used in many existing payment systems, such as Bitcoin, tree-hash-and sign works as follows:

Suppose a verifier V wants to tree-hash-and-sign a list of payments PAY=(P₁, . . . , Pₙ). Note that tree-hash-and-sign may be used analogously on any list of records, such as a list of players' accounts information. First, the verifier builds a Merkle tree of the list PAY, inductively starting from the leaves and converging at the root. The leaves of the tree are associated with level 0 and the root of the tree is associated with level q=log n (for simplicity, suppose that n=2^{q} for some q). To compute the Merkle tree, the verifier first hashes the individual payments Pᵢ and associates the hashes to the leaves of the tree: h⁰ᵢ=H(Pᵢ). Then, inductively, the verifier computes a hash for a node by hashing two of the children of the node. In particular, to compute a hash hⁱⱼ for a node at level i (in range 1, . . . , q), let^{h}^{^{i−1}}_{c} and h^{h}^{^{i−1}}_{c′} be the two hashes for the children of the node. Then,

hⱼⁱ=H(h_{c}ⁱ⁻¹, h_{c′}ⁱ⁻¹)

The hash h_{T}=h₁^{q}, associated with the root of the tree, is a “commitment” to the entire list of payments PAY. For example, suppose PAY=(P₁, P₂, P₃, P₄), then the Merkle tree the verifier would compute to:

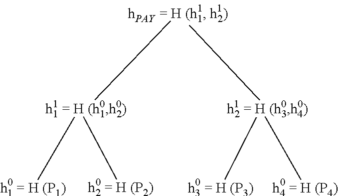

To authenticate the list, the verifier may publicize a single digital signature SIG_{V}(t; h_{PAY}), where t denotes the time. Now, a self-standing V-authenticated record about Pᵢ consists of:
1. the payment Pᵢ itself (and optionally the hash of every node in the path from the leaf corresponding to Pᵢ, h⁰ᵢ=H(Pᵢ), to the root, h_{PAY}), and
2. the hashes of all siblings of the nodes along that path (together with any payments associated with the leaves it downloads) and
3. V's digital signature of the hash of the root, SIG_{V}(t, h_{PAY}).

For instance, in the above example, the self-standing V-authenticated record about the payment P₁ consists of:

(1) P₁ (and optionally, h₁⁰, h₁¹, h_{PAY}),

(2) the associated sibling hashes h₂⁰ and h₂¹ and the payments at the leaves P₁, P₂, and

(3) SIG_{V}(t, h_{PAY}).

To verify this authenticating record of Pᵢ one can:

(1) verify the signatures of the individual payments at the leaves,

(2) compute the hash of the root, h_{PAY}, by recomputing, in a bottom-up fashion, the hash of every node along the path to the root (In fact for each such node he has already computed the hash of one of its children, c, and has retrieved the hash of the other child, that is, of the sibling of c) and

(3) verify the signature of the root: SIG_{V}(t; h_{PAY}).

Again, referring to the above example, the owner would check that P₁ and P₂ are valid payments, whether

h_{T} [symbol] H(H(H(P₁), H(P₂), h₂¹)

and that SIG_{V}(t; h_{PAY}) is a valid signature.

It is easy to see that the verifier's computation is very efficient. The verifier only needs to evaluate an efficient hash function (for example, SHA-512) to construct the Merkle tree. Hence, the total number of hashes the verifier needs to compute for n payments is 2n−1 (corresponding to the total number of nodes in the tree). Since hashing is very efficient, it would take less than a second for a standard computer to produce a Merkle tree for, say, a million payments. Then, the verifier needs to produce a single digital signature authenticating the entire list. For example, using one of the standard Elliptic-Curve Signature Algorithms, the time it would take to produce such a signature would be around 2 milliseconds, and would be around 200 bytes (including a large amount of useful information deemed useful).

It is also easy to see that the player needs to download very little information from the verifier and that computation of the tree is efficient. In particular, the player downloads the path consisting of log n hashes, the sibling log n hashes (and the two payments at the leaves in clear). Since a logarithmic function remains very small even for astronomically large n, the total number of hashes the player needs to download and recompute remains very small. Moreover, the player only needs to perform a few (three) signature verification algorithms.

Using a standard Elliptic-Curve Signature Algorithms (used in Bitcoin and other payment systems), below is a table highlighting the efficiency of tree-hash-and-sign. It is easy to see that even for 1 Billion payments, only (approximately) 31 Kilobytes needs to be downloaded by a player. Since even a cellphone with a weak internet connection can download at a rate of (at least) 1 Megabyte per second, this download rate can easily be handled. Moreover, the verification time remains very small, and is largely dominated by the verification of the signatures.

TABLE 1
Tree-hash-and-sign approximate efficiency evaluation.

| | | PDownload Size | PVerify Time |
|---|---|---|---|
| # of Payments | Path Length | (KB) | (ms) |
| 128 | 7 | 8 | 10 |
| 1024 | 10 | 11 | 10 |
| 32768 | 15 | 16 | 10 |
| 1048576(≈10⁶) | 20 | 21 | 11 |
| 1073741824(≈10⁹) | 30 | 31 | 11 |

Above, “Path Length” stands for a length of a path of hashes a player needs to download to authenticate a payment; “PDownload Size” stands for a player's total number of Kilobytes that need to be download; “PVerify Time” for player's time (in milliseconds) to verify a record (for a standard cellphone).

### General Payments and Settlement Systems

It should be realized by those skilled in the art that payments in the system described herein may transfer more than money from one user/public key to another and may transfer something different than money.

In particular, rather transferring money, a payment may transfer a given number of stock shares of a given security. For instance, at each round t, a key PK may be associated to/own a given amount of money, as well as a first number of stock shares of a first security, a second number of stock shares of a second security, etc.

For instance, an entry (PK, #A, I) in STATUSₜ may specify the number of stocks, #A, that PK owns of a given security specified in I. More generally, #A may specify (possibly an amount of money owned by PK and) a sequence of numbers of stock shares, and I the corresponding sequence of securities owned by PK.

For instance, in a payment P=SIG_PK(PK, PK′, #A, I), #A may denote the number of stocks transferred from PK to PK′, and the information I may also specify the security in question (and possibly the price paid by PK′ to PK). PK′ may countersign P to signal the consent of the owner of PK to pay the price to PK, or separately digitally sign a separate money-transfer payment P′ from PK′ to PK, in which the information field I′ links the payment to the payment P, so that verifiers may verify whether one payment can be deemed valid alone, or both or none can be deemed valid. More generally, #A may specify a sequence of numbers of stock shares, and I may specify the corresponding sequence of securities. Alternatively I may also specify the number of stock shares of various securities to be transferred by PK′ to PK.

When a verifier Vi checks the validity of such a payment P in round t, the verifier also checks that in the previous round PK indeed had a proper number of stocks of the specified security. In sum, the payment system described herein should be understood to include a settlement system.

Bitcoin relies on a very complex and space- and time-inefficient mechanism to ensure that the status of the system cannot be subverted, and that no sufficiently large fractions of the “mining computers” are controlled by a single entity, an assumption that may become more difficult to maintain as mining agents consolidate. By contrast, Democoin relies on a very simple and very efficient mechanism, and cannot be subverted if a reasonable majority of the users are honest. Moreover, even obsolete knowledge about the status of the system suffices to reconstruct true current status of the system with sufficient accuracy.

Various embodiments discussed herein may be combined with each other in appropriate combinations in connection with the system described herein. Additionally, in some instances, the order of steps in the flowcharts, flow diagrams and/or described flow processing may be modified, where appropriate. Subsequently, elements and areas of screen described in screen layouts may vary from the illustrations presented herein. Further, various aspects of the system described herein may be implemented using software, hardware, a combination of software and hardware and/or other computer-implemented modules or devices having the described features and performing the described functions.

Software implementations of the system described herein may include executable code that is stored in a computer readable medium. The computer readable medium may be non-transitory and include a computer hard drive, ROM, RAM, flash memory, portable computer storage media such as a CD-ROM, a DVD-ROM, a flash drive, an SD card and/or other drive with, for example, a universal serial bus (USB) interface, and/or any other appropriate tangible or non-transitory computer readable medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

1. A method of verifying electronic payments in an electronic payment system in which at each of multiple rounds there is a set of players V, such that a payment is valid if the payment is authenticated to be valid by a given majority of the players in V, comprising:
having a player Vi in V receive authentication of multiple payments during one of the multiple rounds of the electronic payment system;
having Vi determine which of the multiple payments are valid;
having Vi authenticate a subset of the multiple payments that Vi determines valid to provide an authenticated payment record; and
having Vi cause the authenticated payment record to become widely available to enable at least another entity to determine whether a given payment authenticated valid by Vi is authenticated to be valid by the given majority of the players in V.

2. A method as recited in claim 1, wherein the authentication of at least one multiple payments includes a digital signature, determining which of the multiple payments are valid includes verifying the digital signature, wherein authenticating the subset of multiple payments includes digitally signing data indicating the subset of multiple payments, and wherein having Vi cause the authenticated payment record to become widely available includes at least one of: posting the authenticated payment record on a website, sending the authenticated payment record to another entity that further disseminates the authenticated payment record, and sending the authenticated payment record to another entity that posts the authenticated payment record on a website.

3. A method as recited in claim 2, wherein digitally signing data indicating the subset of multiple payments includes using a single digital signature and the data includes at least one of: information about the round, time information, and other additional information.

4. A method as recited in claim 3, wherein each valid payment transfers money associated with a first public key to a second public key and wherein each valid payment is digitally signed relative to the first public key.

5. A method as recited in claim 4, wherein having Vi determine which of the multiple payments are valid includes determining if sufficient funds are available for each of the multiple payments.

6. A method as recited in claim 1, wherein the set of players V is randomly selected from a larger set of potential verifiers using a closeness-preserving selection process.

7. A method as recited in claim 2, wherein the set of players V is randomly selected from a larger set of potential verifiers using a natural and public random value associated with the one of the multiple rounds of the electronic payment system.

8. A method as recited in claim 3, wherein Vi is randomly selected from a set of potential verifiers by a special entity T that produces a digital signature showing that Vi has been selected and causes the signature to become widely available.

9. A method as recited in claim 8, wherein the digital signature of T authenticates at least one of: information including a natural and public random value, information including time information, information including information about the one of the multiple rounds of the electronic payment system, and other information.

10. A method as recited in claim 3, wherein Vi is randomly selected from a set of potential verifiers by a set of special entities by combining digital signatures produced by the entities.

11. A method, according to claim 1, wherein Vi is provided with a reward for authenticating the subset of the multiple payments that Vi determines valid.

12. A method, according to claim 11, wherein an amount of the reward is based on at least one of: a value of the multiple payments that Vi determines valid and a number of missed payment.

13. A method, according to claim 11, wherein the rewards are paid by at least one of: a portion of the valid payments and retailers that receive payments.

14. A method of verifying electronic payments in an electronic payment system, comprising:
receiving records for multiple payments from a plurality of players of the electronic payment system during a particular one of a plurality of rounds of the electronic payment system;
determining which of the multiple payments are valid;
authenticating valid payments to provide an authenticated payment record for each of the valid payments; and
making the authenticated payment record available for accessing, wherein in the electronic payment system, a payment in a particular round is deemed valid if a given majority of a subset of the players authenticate as valid the particular payment to provide an authenticated payment record.

15. Computer software, provided in a non-transitory computer readable medium, that verifies electronic payments in an electronic payment system, the software comprising:
executable code that implements the method of claim 1.

16. A method of facilitating verification of an electronic payment in an electronic payment system, comprising:
determining if authenticated payment records provided by a given majority of entities indicate validity of the electronic payment between a first player and a second player of the electronic payment system during a particular one of a plurality of rounds of the electronic payment system;
generating an authenticated string vouching that the payment has been verified by the given majority of entities in response to the payment being verified by the majority of verification entities; and
causing the authenticated string to become widely available.

17. A method as recited in claim 16, wherein the authenticated string is a digital signature and causing the authenticated string to become widely available includes at least one of: posting the authenticated string on a website, transmitting the authenticated string to another entity that causes the authenticated string to become widely available, and transmitting the authenticated string to another entity that posts the authenticated string on a website.

18. A method as recited in claim 16, wherein the authenticated payment records are digitally signed.

19. Computer software, provided in a non-transitory computer readable medium, that facilitates verification of an electronic payment in an electronic payment system, the software comprising:
executable code that implements the method of claim 16.

20. A method of issuing a digital certificate for a particular player in a set of players V that make electronic payments in an electronic payment system in which at each of multiple rounds a payment is valid if the payment is authenticated to be valid by a given majority of the players in V, comprising:
obtaining a public key PK_{X} to be used in connection with electronic payments by the particular player;
obtaining additional information to be certified; and
providing certification of PK_{X} and of the additional information for the digital certificate by digitally signing, with a digital signature of a distinguished entity, PK_{X} and the additional information, wherein certification by the distinguished entity is recognized by a significant number of the given majority of the players in V that determine validity of payments made by the players in the electronic transaction system.

21. A method as recited in claim 20, wherein the additional information includes at least one of: identity information about the distinguished entity, identity information about the particular player, qualifying information about the particular player, time information relating to the digital certificate, monetary information associated with PK_{X}, territorial information, and transaction restrictions associated with PK_{X}.

22. A method as recited in claim 21, wherein the monetary information associated with PK_{X} includes an amount of money in the electronic transaction system that is possessed by the particular player.

23. A method as recited in claim 21, wherein the identity information about the particular player includes at least one of: the name of the particular player, a hash of the name of the particular player, an encryption of the name of the particular player, and an index to a data structure containing information that identifies the particular player.

24. A method as recited in claim 23, wherein the identity information about the particular player is an encryption of the name of the particular player and wherein a governmental entity uses a decryption key to determine the identity of the particular player.

25. A method as recited in claim 20, further comprising:
performing additional actions; and
in response to a result of the additional actions being satisfactory, issuing the digital certificate containing the certification of PK_{X} and of the additional information.

26. A method as recited in claim 25, wherein the additional actions include at least one of: verifying at least some of the additional information, confirming willingness of the particular player to use PK_{X} in the electronic transaction system, confirming that the particular player knows a secret signing key associated with PK_{X}, assisting the particular player to obtain PK_{X}, providing the particular player with PK_{X}, confirming that a signing key corresponding to PK_{X} has been escrowed, providing an initial amount of money to the particular player to be used in the by the electronic transaction system, determining an identity of the particular player, escrowing the information used to identify the particular player, and confirming that the particular player is eligible to have PK_{X} certified.

27. A method as recited in claim 25, wherein the additional actions include confirming that the particular player is eligible to be a member of the given majority of the players in V.

28. A method as recited in claim 20, wherein the distinguished entity is provided with a reward for at least one of: issuing the digital certificate and each electronic payment made by the particular player.

29. A method, according to claim 28, wherein the reward is provided as an electronic payment to the distinguished entity through the electronic payment system.

30. A method, according to claim 28, wherein the reward is paid by one of: a retailer, the particular player, and a recipient of an electronic payment made by the particular player.

31. A method, according to claim 20, wherein the distinguished entity is a financial institution.

32. Computer software, provided in a non-transitory computer readable medium, that issues a digital certificate for a particular player in a set of players V that make electronic payments, the software comprising:
executable code that implements the method of claim 20.
